(19) United States
(12) Patent Application Publication
(10) Pub. No.: US 2016/0127771 A1
(43) Pub. Date: May 5, 2016

(54) SYSTEM AND METHOD FOR TRANSPORTING HD VIDEO OVER HDMI WITH A REDUCED LINK RATE

(71) Applicant: Broadcom Corporation, Irvine, CA (US)

(72) Inventors: Christopher Pasqualino, Laguna Niguel, CA (US); Richard S. Berard, Pasadena, CA (US)

(73) Assignee: Broadcom Corporation, Irvine, CA (US)

(21) Appl. No.: 14/925,733

(22) Filed: Oct. 28, 2015

Related U.S. Application Data
(60) Provisional application No. 62/072,913, filed on Oct. 30, 2014.
(60) Provisional application No. 62/080,532, filed on Nov. 17, 2014.

(51) Int. Cl. H04N 21/4363; H04N 21/43; H04N 21/434; H04N 19/65; H04N 21/4402

(52) U.S. Cl. CPC H04N 21/43635; H04N 19/65; H04N 21/440236; H04N 21/4343; H04N 21/4302

(57) ABSTRACT

In some aspects, the disclosure is directed to methods and systems for transporting multimedia data, such as ultra-high definition (UHD) video data or other video data, via a standard high-definition multimedia interface (HDMI), without requiring an increase in the link bit rate or increasing the number of signaling pairs. Display stream compression is utilized to compress a stream, and a transition minimized differential signal (TMDS) clock channel may be replaced by an ANSI 8b/10b encoded stream carrying additional data with a clock signal embedded within the stream. As this additional channel increases bandwidth by one-third, the systems and methods discussed herein provide four times more effective bandwidth than prior HDMI schemes, allowing UHD video to be transmitted via a signal HDMI link.

### CROSS-REFERENCE TO RELATED APPLICATIONS

This application claims the benefit of and priority to U.S. Provisional Application No. 62/072,913, entitled “SYSTEM AND METHOD FOR TRANSPORTING HD VIDEO OVER HDMI WITH A REDUCED LINK RATE,” filed Oct. 30, 2014. This application also claims the benefit of and priority to U.S. Provisional Application No. 62/080,532, entitled “SYSTEM AND METHOD FOR TRANSPORTING HD VIDEO OVER HDMI WITH A REDUCED LINK RATE,” filed Nov. 17, 2014. Both U.S. Provisional Application No. 62/072,913 and 62/080,532 are hereby incorporated by reference herein in their entireties.

### FIELD OF THE DISCLOSURE

This disclosure generally relates to systems and methods for transporting multimedia data. In particular, this disclosure relates to systems and methods for transporting high definition multimedia data via a high-definition multimedia interface (HDMI).

### BACKGROUND OF THE DISCLOSURE

HDMI is utilized for transmitting digital multimedia signals including audio and video from digital video disk or digital versatile disk (DVD) players, set-top boxes, and other audio-visual sources to television sets, monitors, projectors, computing devices, devices that receive and retransmit video (e.g. audio/video receivers and other), or other video receivers, repeaters, or displays. The HDMI 2.0 specification provides support for high video resolutions, up to 4096×2160 lines (“4K video”) at 60 frames per second, and multichannel audio, over a single 19-pin cable. Data is transferred with transition minimized differential signaling (TMDS) coding at a maximum throughput of 18 Gbit/s. However, ultra high definition television (UHD) devices are now being created with capabilities up to 7680 pixels×4320 lines (“8K video”), requiring 48 Gbit/s for transfer of uncompressed video without the inclusion of blanking periods.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram of an HDMI source and sink, according to some embodiments;

FIG. 1B is a diagram of Bose, Chauduri, Hocquenghem (BCH) encoded blocks and sub packets according to some embodiments of the HDMI specification;

FIG. 1C is a diagram of a mapping of BCH blocks to TMDS channels according to some embodiments of the HDMI specification;

FIG. 2A is a diagram of several options for adjustment of video container timing, according to some embodiments;

FIG. 2B is a diagram of container loading, according to some embodiments;

FIG. 2C is a diagram of mapping of BCH blocks protecting two HDMI Packets to TMDS channels according to some embodiments;

FIG. 2D is a diagram of mapping of BCH blocks protecting three HDMI Packets to TMDS channels according to some embodiments;

FIG. 2E is another diagram of mapping of BCH blocks to TMDS channels, according to some embodiments;

FIG. 2F is a diagram illustrating placement of Display Stream Compression (DSC) data in channels, according to some embodiments;

FIG. 3A is a diagram of placement of packets within a video frame, according to some embodiments;

FIG. 3B is another diagram of placement of packets within a video frame, according to some embodiments;

FIG. 3C is a diagram of parity bits corresponding to channel data, according to some embodiments;

FIG. 3D is a diagram of mapping of parity bits to TMDS channels, according to some embodiments;

FIG. 3E is a diagram illustrating mini-packet insertion within a video line, according to some embodiments;

FIG. 4A is a chart of supported audio and video rates for the mapping of BCH blocks to TMDS channels shown in FIG. 2C, according to some embodiments;

FIG. 4B is a chart of supported audio and video rates for the mapping of BCH blocks to TMDS channels shown in FIGS. 2D-2E, according to some embodiments;

FIGS. 5A-5D are charts of additional supported audio and video rates at additional compression and timing rates for the mapping of BCH blocks to TMDS channels shown in FIGS. 2D-2E, according to some embodiments, where FIG. 5A illustrates audio capabilities with 8 bpp compression and timing, FIG. 5B illustrates audio capabilities with 10 bpp compression and timing, FIG. 5C illustrates audio capabilities with 12 bpp compression and timing, and FIG. 5D illustrates audio capabilities with 16 bpp compression and timing, according to some embodiments;

FIG. 6A is a diagram showing a mapping from a video timing to a video container, according to some embodiments;

FIG. 6B is a chart of some example container timings, according to some embodiments;

FIG. 7 is a chart of a configuration of picture parameter set (PPS) syntax elements and corresponding compressed bits per pixels (bpps), according to some embodiments;

FIG. 8A is a diagram of an example of standard packet transmission, according to some embodiments;

FIG. 8B is a diagram of an example of 2-packet super-packets, according to some embodiments;

FIG. 8C is a diagram of an example of 3-packet super-packets, according to some embodiments;

FIG. 9A is a diagram of an example of standard packets loaded into 2-packet super-packets, according to some embodiments;

FIG. 9B is a diagram of an example of naming bits for subpacket n for loading into a 2-packet super-packet and 3-packet super-packet, according to some embodiments;

FIG. 9C is a diagram of an example of naming bits for subpacket “n+1” for loading into a 2-packet super-packet, according to some embodiments;

FIG. 9D is a diagram of an example of bit placement in 2-packet super-packets, according to some embodiments;

FIG. 10A is a diagram of an example of loading standard packets into 3-packet super-packets, according to some embodiments;

FIG. 10B is a diagram of an example of naming bits for subpacket “n+1” for loading into a 3-packet super-packet, according to some embodiments;

FIG. 10C is a diagram of an example of naming bits for subpacket “n+2” for loading into a 3-packet super-packet, according to some embodiments;

FIG. 10D is a diagram of an example of bit placement in 3-packet super-packets, according to some embodiments;

FIG. 11 is a chart of an example of preambles for each data period type, according to some embodiment; and

FIGS. 12A and 12B are block diagrams depicting embodiments of computing devices useful in connection with the methods and systems described herein.

The details of various embodiments of the methods and systems are set forth in the accompanying drawings and the description below.

### DETAILED DESCRIPTION

The present HDMI specification provides sufficient bandwidth for 4K video data encoded via TMDS. In addition, it provides sufficient bandwidth for a wide variety of audio sample rates and formats, encoded via TMDS Error Reduction Coding (TERC4). TERC4 encoding maps sixteen 4-bit characters to 10-bit symbols and includes signaling for guard bands. TERC4 symbols and guard band symbols, generally referred to as HDMI symbols, are 10-bits in length and have five logic ones and five logic zeros to ensure that they are DC balanced. HDMI links include three TMDS data channels, which carry the TMDS and TERC4 encoded data, and one TMDS clock channel.

8K video data requires significantly greater bandwidth, as the number of both horizontal and vertical lines are doubled from 4K video. Providing improved cabling or a greater number of signaling pairs in a cable may result in increased expense and complexity, as well as increasing the number of potential connector types. Instead, the systems and methods discussed herein provide support for 8K video data at 60 frames per second without requiring an increase in the link bit rate or increasing the number of signaling pairs according to some embodiments. Additionally, audio throughput is maintained, allowing 8 channels of 192 kHz pulse code modulated (PCM) audio or a high bitrate (HBR) compressed audio packet stream at 768 kHz. In some embodiments, DSC, promulgated by the Video Electronics Standards Association (VESA), is utilized to compress a 24-bit 4:4:4 or 4:2:2 chroma subsampled stream to 8 bits per pixel (bpp), 10 bpp, or 12 bpp, depending on compression level configuration according to some embodiments. This reduces video throughput requirements by a factor of three or more in some embodiments. To further provide additional bandwidth, the TMDS clock channel is replaced, for example, by an ANSI 8b/10b encoded stream, referred to herein as channel 3 or TMDS channel 3, carrying additional data with a clock signal embedded within the stream in some embodiments. In some embodiments, other encoding methodologies can be used, for example, an 128b/132b encoding, further expanding the available bandwidth. As this additional channel increases bandwidth by one-third, the systems and methods discussed herein provide 4 times more effective bandwidth at a given character rate than prior HDMI schemes, allowing 8K video to be transmitted via a single HDMI link according to some embodiments.

In some embodiments, configuration data is transmitted via a status and control data channel (SCDC) to identify the third channel and 8b/10b character rate, allowing the receiver to properly recover the embedded clock in some embodiments. Video is transported via a “Video Container” that looks much like normal 4K “Video Timing” in some embodiments. In some embodiments, forward error correction (FEC) is applied to the compressed video, with FEC parity information provided in standardized packets, referred to as FEC packets. In some embodiments, an FEC packet is transmitted on every video container line having active video. FEC Packets in a burst are the first packets following the active video in the Video Container line, with audio packets following the FEC packets. The embodiments may be compatible with or utilize the high-bandwidth digital content protection (HDCP) 2.2 scheme, and in some embodiments, may remove compatibility with prior HDCP schemes, freeing up additional bandwidth for FEC Parity Data.

Accordingly, in some embodiments, channels 0 through 2 may include TMDS encoded Data Islands, with channel 3 including ANSI 8b/10b encoded data. This system may allow transmission of 2 packets per packet period. In some embodiments, channel 3 may be used to transport additional packet information, such as additional audio data, allowing transmission of 3 packets per packet period. In some embodiments, channels 0 through 2 may include ANSI 8b/10b, for example, encoded data in a similar manner to channel 3. In some embodiments, other encoding methodologies can be used, for example, an 128b/132b encoding, further expanding the available bandwidth.

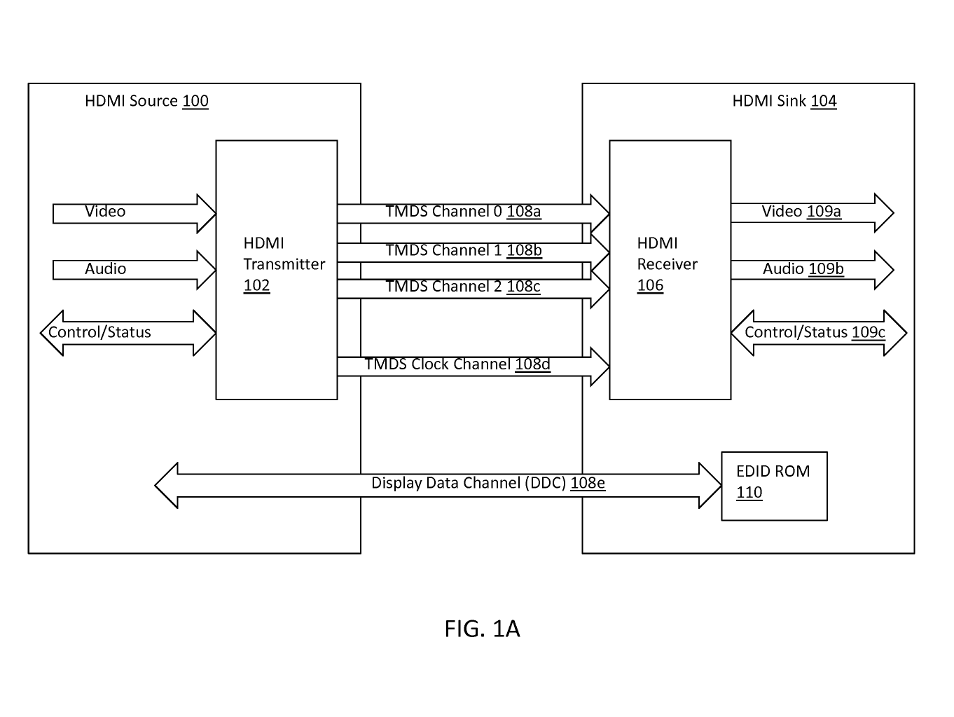

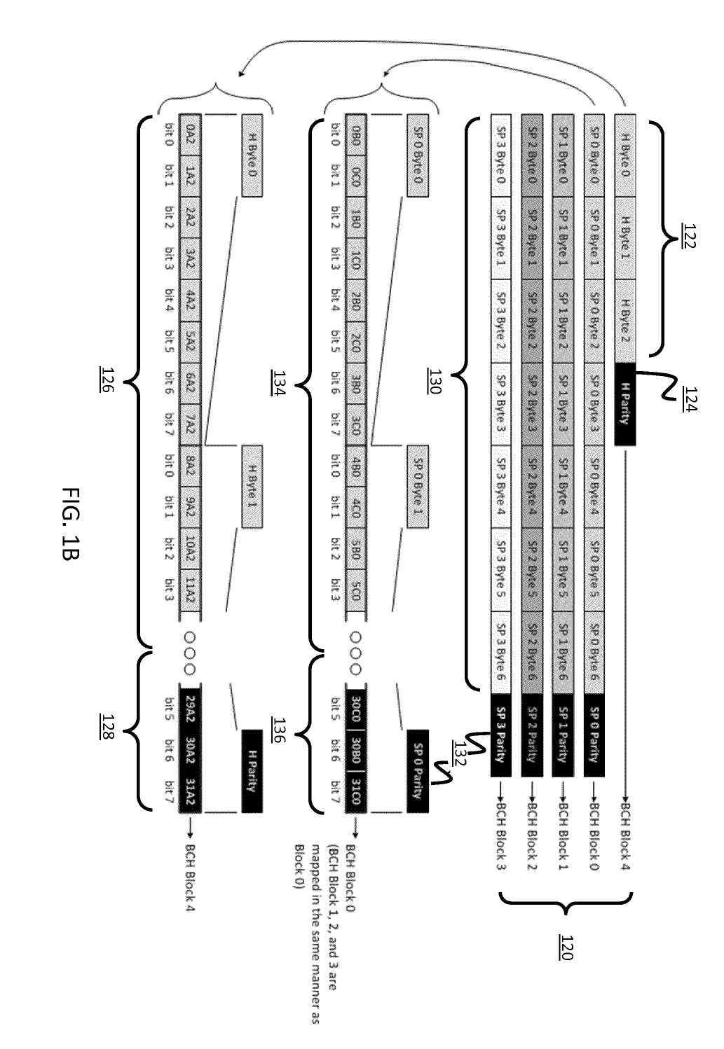

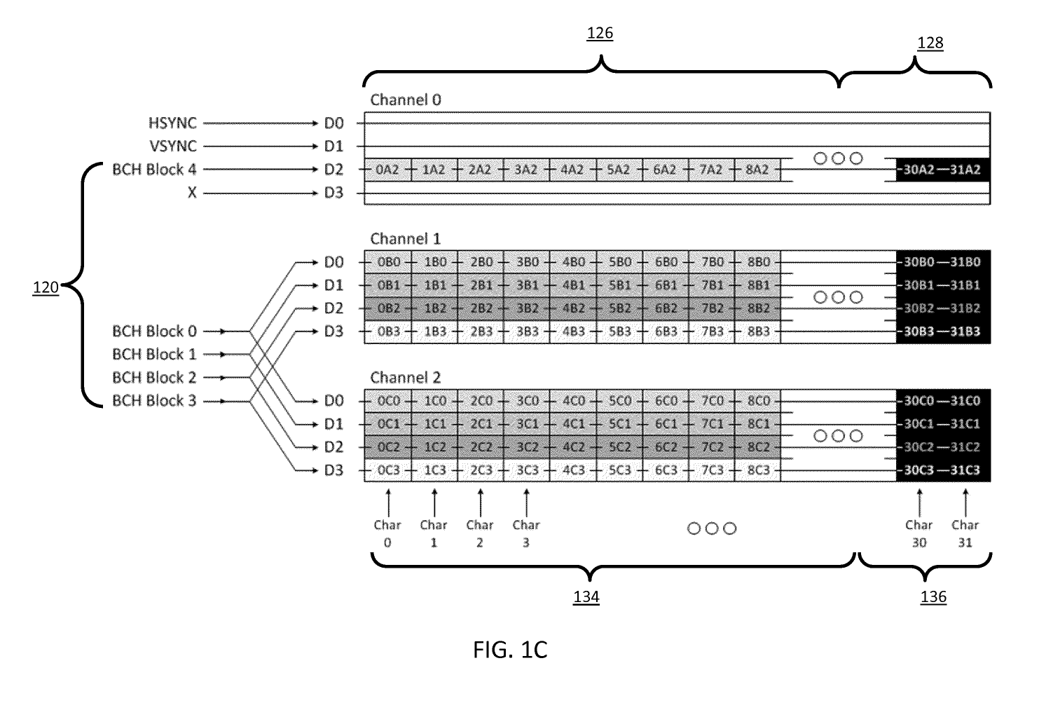

Referring first to FIG. 1A, illustrated is a block diagram of an HDMI system according to some embodiments. An HDMI source 100, including a transmitter 102, communicates with an HDMI sink 104, including a receiver 106 and a memory (e.g., a read only memory (ROM)) 110 in some embodiments. HDMI source 100 is any type and form of media source or media encoder, such as a DVD player, set top box, cable receiver, satellite receiver, terrestrial broadcast receiver, desktop computer, laptop computer, portable computing device, devices that receive and retransmit video (e.g. audio/video receivers and other), or any other such media source. HDMI sink 104 is any type and form of media receiver and/or display, including but not limited to a monitor, a projector, a wearable display, a computer, a communication device, an audio/video switcher or multimedia receiver, or any other type and form of media receiving device.

Transmitter 102 may include suitable logic, circuitry and/or code that may be configured to receive a number of input channels, such as video, audio and auxiliary data (e.g. control or status data) or data from a display data channel (DDC) 108e or other sideband communication channel (e.g., a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or some other custom channel), and generate a number of output TMDS data channels 108a-108c and a clock channel 108d. As discussed above, in some embodiments, clock channel 108d may be considered a TMDS data channel 3, providing additional bandwidth for transmission of compressed 8K video. DDC channel 108e is used for configuration and status exchange between source 100 and sink 104 in some embodiments.

Receiver 106 may comprise suitable logic, circuitry and/or code configured to receive a number of input TMDS data and clock channels 108a-108d, and may generate a number of output channels 109a-109c, such as video and audio channels and control information. Transmitter 102 and receiver 106 may be one or more fixed circuits, field programmable gate arrays (FPGAs), or other modules or combinations of circuits, or may comprise software executed by a processor, such as a microprocessor or central processing unit, including those manufactured by Intel Corporation of Mountain View, Calif.; those manufactured by International Business Machines of White Plains, N.Y.; or those manufactured by Advanced Micro Devices of Sunnyvale, Calif.

Memory 110 may comprise suitable logic, circuitry and/or code configured to store auxiliary data such as an extended display identification data (EDID), which may be received from DDC channel 108e or other sideband communication channel (e.g., a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or some other custom channel). Memory 110 may comprise a serial programmable read only memory (PROM) or electrically erasable PROM (EEPROM), Random Access Memory (RAM), a read only memory (ROM) or any other type and form of memory.

Audio, video and auxiliary data may be transmitted across a number of TMDS data channels 108a-108d. In some embodiments, video data is transmitted as 24-bit pixels on the number of TMDS data channels. TMDS encoding converts a number of bits, for example, 8 bits per channel into a 10 bit DC-balanced, transition minimized sequence in some embodiments. The sequence is transmitted serially at a rate of 10 bits per pixel clock period, or any other such rate in some embodiments. The video pixels are encoded in RGB, YCBCR 4:4:4 or YCBCR 4:2:2 formats, for example, and are transferred up to 24 bits per pixel, for example. In some embodiments, more than 24-bits per pixel (e.g. 30, 36, or 48 bits per pixel in addition to support for 24 bits per pixel) is provided. In some embodiments, as discussed above, pixels are compressed from a 4:4:4 or 4:2:2 24-bit per pixel scheme to an 8 bit per pixel format, such as via DSC compression. Other embodiments are capable of compressing 4:2:0 format pixels.

FIG. 1B is a diagram of BCH encoded blocks 120 and sub packets 122-124, 130-132 for transmission by the HDMI transmitter 102 (see FIG. 1A) during a Data Island according to some embodiments of the HDMI specification.

In some embodiments, TMDS on HDMI uses three different packet types—a Video Data Period, a Data Island Period and a Control Period. In some embodiments, during the Video Data Period, pixels of an active video line are transmitted by the transmitter 102. In some embodiments, during the Data Island period, which may occur during the horizontal and vertical blanking intervals, audio and auxiliary data are transmitted within a series of packets by the transmitter 102. In some embodiments, the Control Period occurs between Video and Data Island periods.

In some embodiments, Data Islands are 4b10b TERC4 encoded. As shown in FIG. 1B, BCH blocks 120 includes header bytes 122 and a header parity byte 124, which may be divided into bits 126 and 128, respectively, in some embodiments. Similarly, BCH blocks 120 include subpackets 130 and parity bytes 132, which may be divided into subpacket bits 134 and parity bits 136, respectively, in some embodiments. In some embodiments, each of BCH blocks 120 is mapped to a corresponding one of the TMDS data channels 108a-108c and clock channel 108d. In some embodiments, each BCH block is mapped to one or more channels of the TMDS data channels 108a-108c and clock channel 108d. Different mapping methods are described below. In some embodiments, once BCH blocks are mapped to TMDS channels, the header bytes 122, header parity byte 124, subpackets 130 and parity bytes 132 of BCH blocks are transmitted by the transmitter 102 via respective mapped TMDS channels.

FIG. 1C is a diagram of a mapping of BCH blocks to TMDS channels 0-2 according to some embodiments of the HDMI specification. As shown in FIG. 1C, HSYNC, VSYNC, header packet bits 126, and parity bits 128 are transmitted via a first TMDS channel 0 in some embodiments. As shown in FIG. 1C, alternate bits 134, 136 from subpackets are provided to TMDS channels 1 and 2 for each BCH block (e.g. 0B0 being provided to bit 0 of channel 1, 0C0 being provided to bit 0 of channel 2, etc.). Packets are grouped into 4 bit groups (D0-D3) for input to the 4b10b TERC4 encoder of the transmitter, in some embodiments.

As discussed above, with respect to some embodiments illustrated in FIGS. 1A-1C, sufficient bandwidth for 4K video is provided. To support 8K video, DSC compression is applied to the video data and the TMDS clock channel is optionally used as a fourth data channel, in some embodiments. Various pixel data sizes comprised of, for example, three color/luminance components, may be utilized, including 8 bits per component, 10 bits per component, 12 bits per component, or any other such size, and a compressed data rate of 8 bits per pixel may provide visually lossless coding performance with standard content. Latency is reduced via parallel DSC encoders and decoders, such as one encoder or decoder per channel or one encoder or decoder per vertical slice of a video frame, in some embodiments. FEC protection may provide for recovery in case of intermittent errors.

In some embodiments, a picture parameter set (PPS) is transmitted by the source to the sink via, for example, a PPS packet or packets, to communicate information necessary to decode the DSC compressed picture. The PPS packet transports up to 28 bytes in duration in some embodiments, and optionally includes one or more reserved bits in some embodiments. In some embodiments, several PPS packets transport a PPS of more than 28 bytes in duration, for example 128 bytes in duration, and include one or more reserved bits. In some embodiments packets capable of carrying more than 28 bytes are implemented so that only a single packet is needed to transmit a large number of PPS bytes, for example 128 bytes. PPS packets may be transmitted prior to every video field, and may be transmitted in a burst of 5 subpackets at any free data island during the vertical blanking interval (VBI). In some embodiments, the burst are interrupted by audio packets. When DSC is active, in some embodiments, PPS packets are transmitted anywhere during the VBI immediately preceding the frame to which they apply. In some embodiments, the sink or receiver receives the packets and assemble the PPS, and extracts configuration information from the assembled PPS and configures the DSC decode function. In some embodiments, each PPS packet includes a predetermined byte, such as a first byte PB0, set to a predetermined value (e.g. 1-5) to indicate which subgroup of bytes of the PPS is being transmitted within the packet. In some embodiments, each packet includes 27 bytes of the PPS.

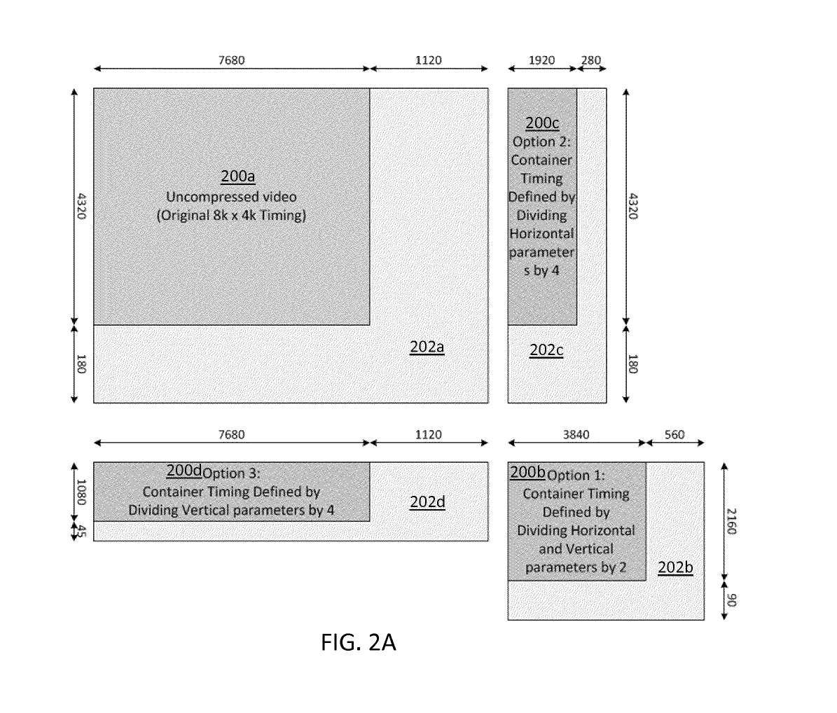

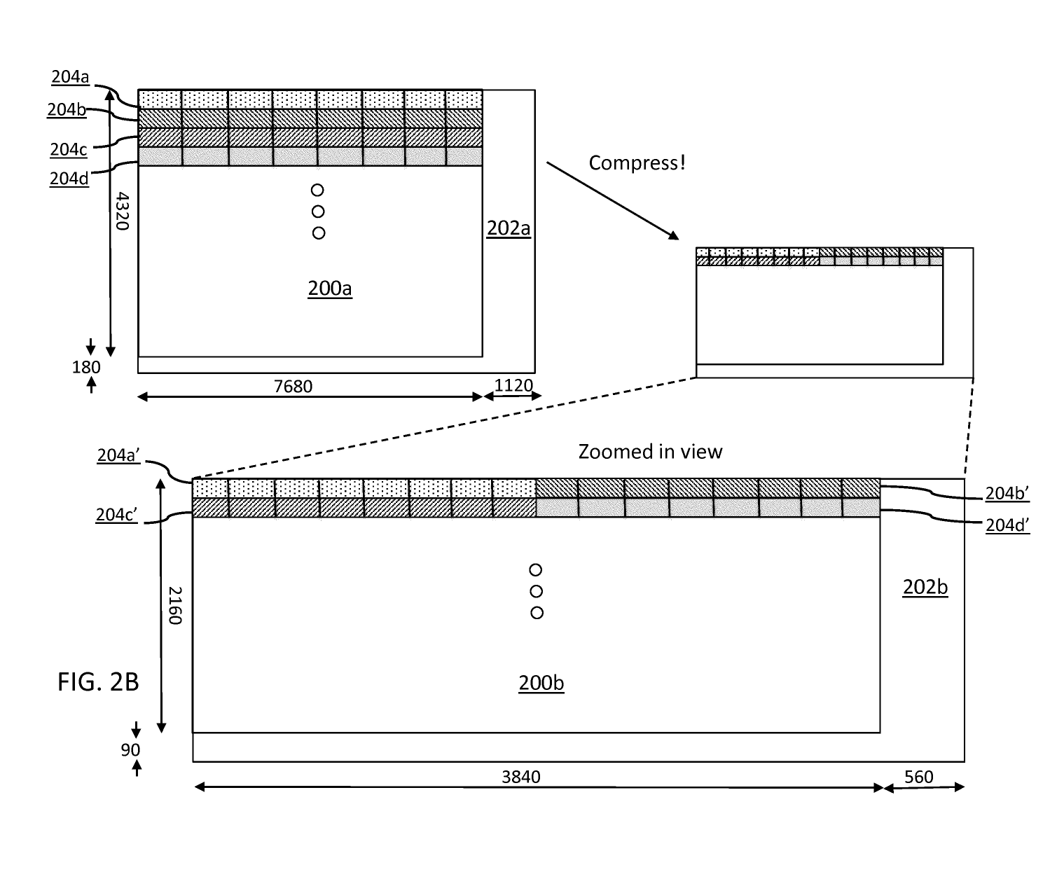

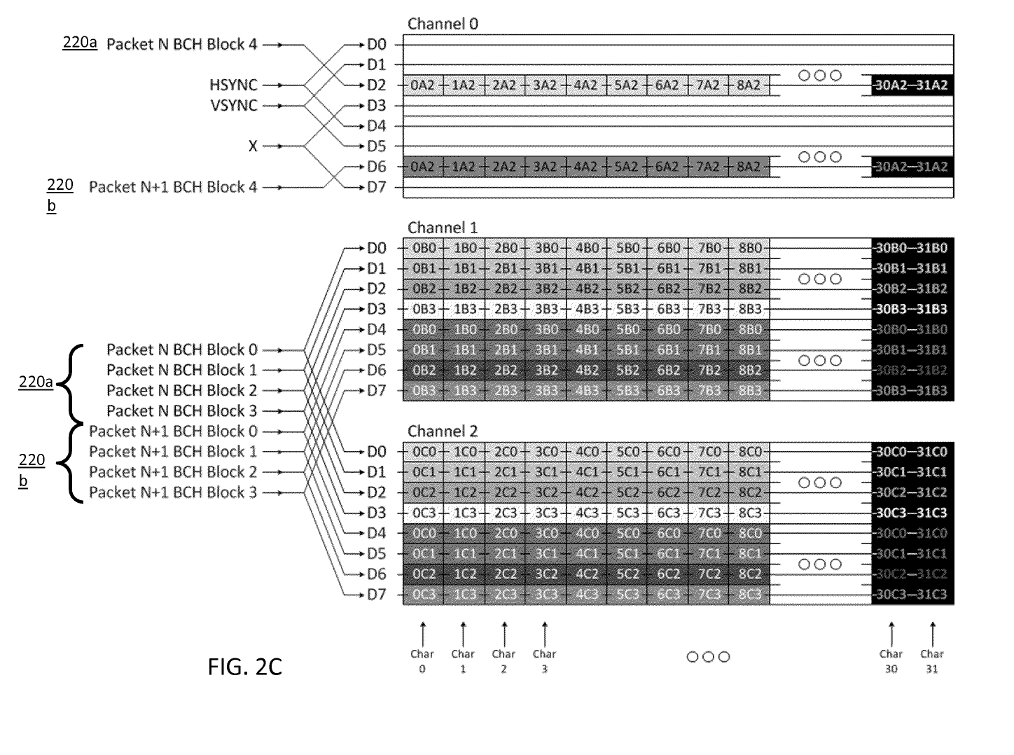

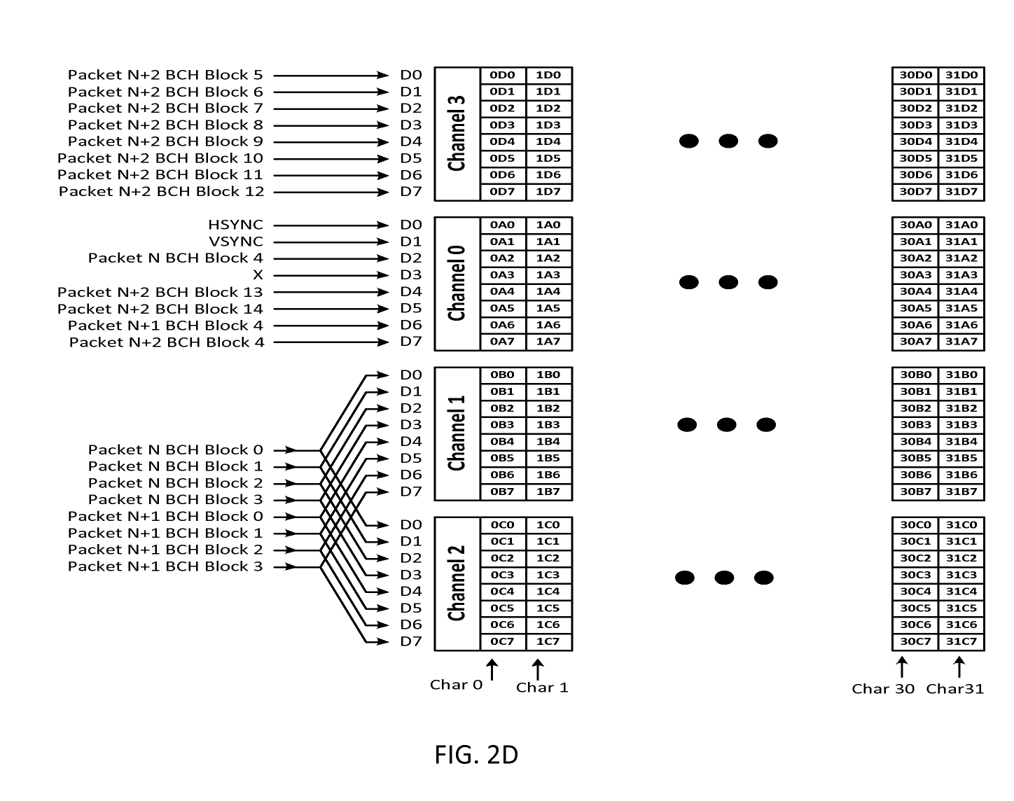

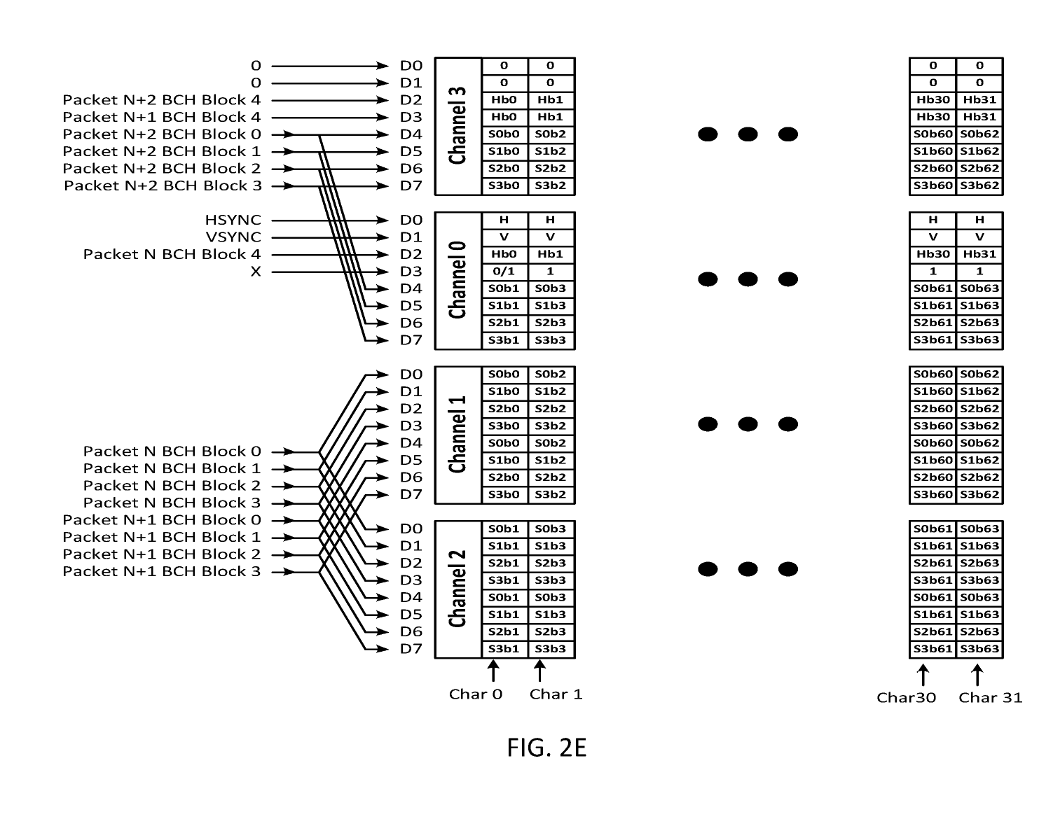

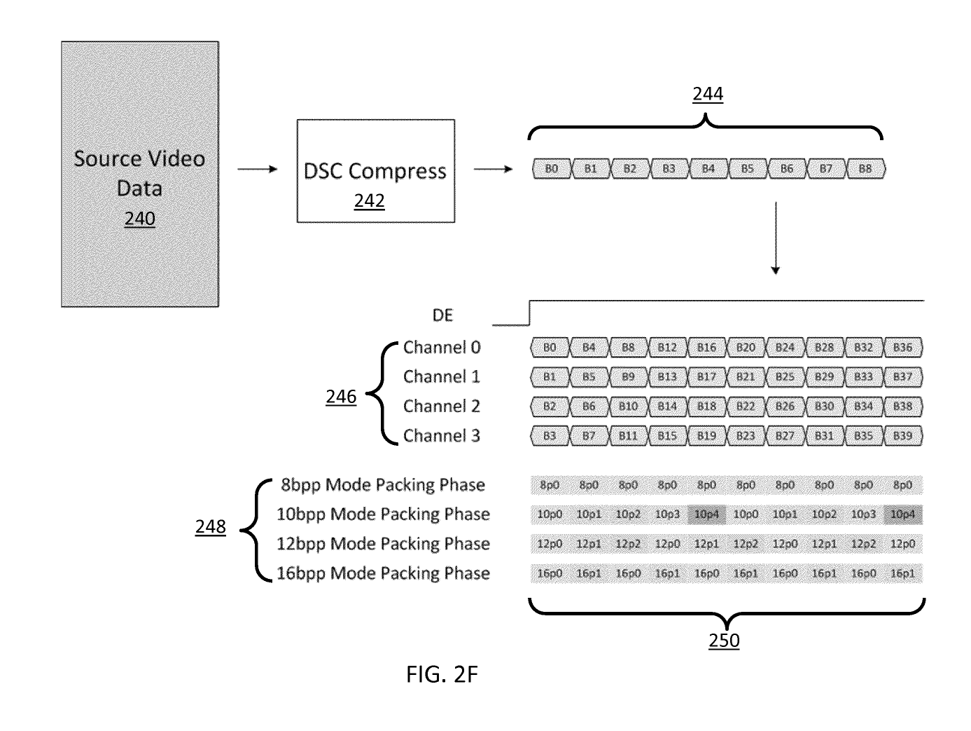

FIG. 2A is a diagram of several options for adjustment of video container timing, according to some embodiments. In some embodiments, as shown in the upper left of FIG. 2A, an original 8K video frame includes uncompressed video 200a and horizontal and vertical blanking intervals 202a (not shown to scale). A video-like timing is retained when compressing the video to keep the embodiment compatible with existing standards, in some embodiments. For example, as shown in the upper left of FIG. 2A, the original 8K video frame has timing defined by 7680 horizontal active pixels, 1120 horizontal blanking pixels, 4320 vertical active lines, and 180 vertical blanking lines. Other video frame timings are possible.

In a first option, illustrated in the lower right of FIG. 2A, the defined vertical and horizontal parameters may be divided by two, reducing the overall active video period 200b by a factor of four and having horizontal and vertical blanking intervals 202b. The resulting video container has similar timing to a standard 4K video format. For example, as shown in lower right of FIG. 2A, the resulting video container for the first option has timing defined by 3840 horizontal active pixels, 560 horizontal blanking pixels, 2160 vertical active lines, and 90 vertical blanking lines.

Also illustrated for comparison are a second option, illustrated in the upper right, dividing horizontal parameters by four and having the overall active video period 200c and horizontal and vertical blanking intervals 202c; and a third option, illustrated in the lower left, dividing vertical parameters by four and having the overall active video period 200d and horizontal and vertical blanking intervals 202d. Option two may not have sufficient audio bandwidth due to the shortened horizontal blanking interval 202c in some embodiments. For example, as shown in upper right of FIG. 2A, the resulting video container for the second option has timing defined by 1920 horizontal active pixels, 280 horizontal blanking pixels, 4320 vertical active lines, and 180 vertical blanking lines.

Option three provides sufficient audio bandwidth, but may require additional line buffers, as four lines are received from the uncompressed video before a line of compressed video may be output. This may increase latency, as well as the expense of embodiments utilizing option three. For example, as shown in lower left of FIG. 2A, the resulting video container for the third option has timing defined by 7680 horizontal active pixels, 1120 horizontal blanking pixels, 1080 vertical active lines, and 45 vertical blanking lines.

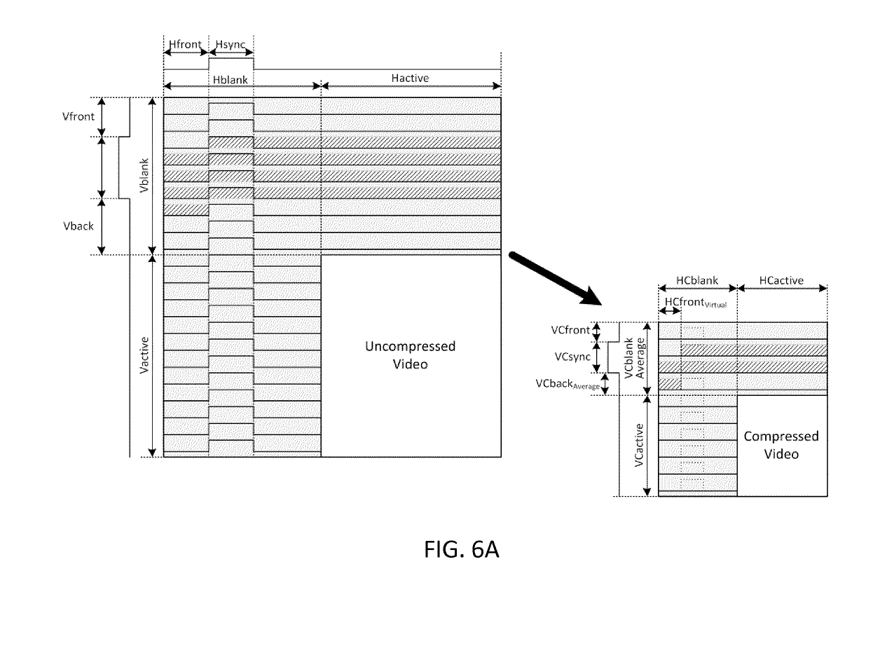

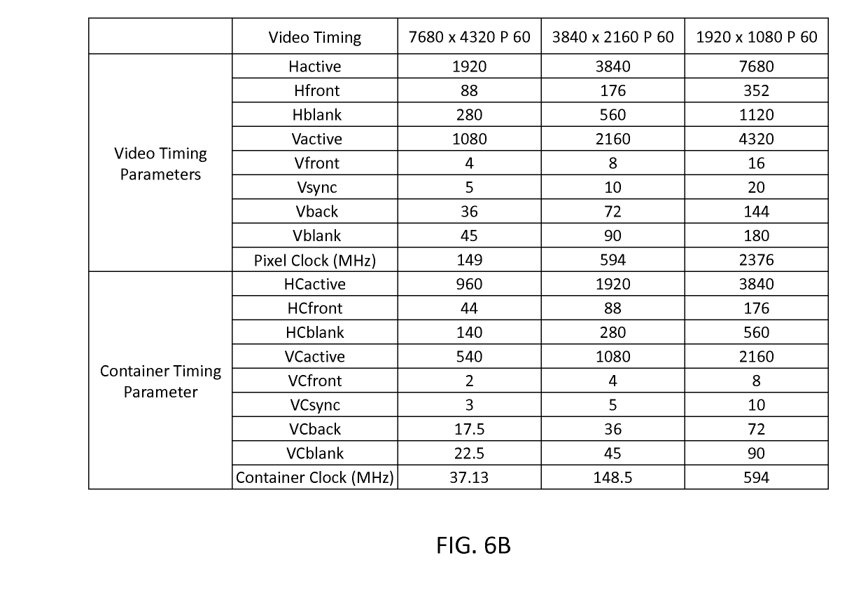

In some embodiments, the options illustrated in FIG. 2A can be implemented by defining container timings in terms of video format timings (or video timings) as shown in FIG. 6A. In some embodiments, the options illustrated in FIG. 2A can be implemented by using example container timings as shown in FIG. 6B. Details of defining container timings will be described below, referring to FIGS. 6A and 6B.

FIG. 2B is a diagram of container loading, according to some embodiments. In some embodiments, the container loading is performed by the transmitter 102 by a compression circuit or module. Uncompressed video data 200a is divided into eight 960-pixel slices for processing amongst several DSC modules, in some embodiments. This may reduce the bandwidth required for each DSC encoder in some embodiments. Vertical slices are depicted for the first 4 lines (204a-204d), with 8 slices per line (S1 to S8) in some embodiments. In some embodiments, a greater or lesser number of slices (and DSC modules) is utilized. Post compression, the video data 200b is configured with the compressed first two lines 204a′-204b′ from the uncompressed video 200a on a first line, the next two lines 204c′-204d′ on the second line, etc., in some embodiments.

In some embodiments, deep color pixel packing is implemented during compression, with a compressed 10-bits per pixel, 12-bits per pixel, or any other such configuration. The container (and blanking period) is deep color packed, allowing for reduced compression levels, in some embodiments. In some embodiments, this allows for increased audio bandwidth, particularly with 4K video or lower resolution formats.

As discussed above, to recover from single bit errors or intermittent character errors, error correction is performed on the 10-bit character domain in some embodiments. In some embodiments, a Hamming Code can be used to correct single bit errors, with minimal overhead. The code format is of any sufficient size, such as Hamming(510,501), able to correct a 1 bit error per a 510-bit block per channel. In some embodiments, block error rates are improved from ˜1E−9 pre-correction to 7.6E−16 post-correction. At 6 Gbps and considering all 4 channels together (aggregate rate=24 Gbps), this translates to a mean time before failure (MTBF) of about 45.5 hours in some embodiments. In some embodiments, a Reed Solomon Code, for example RS(254,250), can be used to correct bit errors. In some embodiments, other error correction schemes are used, such as to correct for multiple-bit errors to further increase the MTBF. The error correction Hamming(510,501) adds approximately 1.76% in overhead during the period in which compressed pixels are being transported: e.g., for 7680 pixels per line input, compressed at 8 bytes per pixel to 7680 bytes; at 2 input lines per compressed container line, or 15360 bytes per line, 2763 FEC parity bits (or 346 bytes) are required, or 13 packets per container line. In some embodiments, such as where errors propagate across BCH blocks, a single FEC engine steps through the 4 channels during parity calculation and generation of FEC packets. This may reduce latency and expense. In some embodiments, each channel has its own error correction, with a dedicated decoder and encoder for each channel. This may simplify design, at additional implementation expense.

To pack two (or more) compressed packets into the same number of 10-bit characters required to transport a single packet under existing HDMI standards, in some embodiments, the systems and methods discussed herein may utilize a “super-packet”. Rather than utilizing TERC4 4b10b coding, the packets are TMDS 8b/10b encoded in some embodiments. In some embodiments, standard TERC4 4b10b coded packets are used, although with a resulting increase in bandwidth requirements. This may be sufficient, depending on resolution and audio bandwidth required. As discussed above, HDCP may be supported in some embodiments, and is required to be HDCP 2.2 with no backwards compatibility to earlier HDCP versions in order to decrease bandwidth requirements. Scrambling and descrambling are also utilized in some embodiments. In some embodiments, three compressed packets may be combined into a super-packet, with ANSI 8b/10b encoding on channel 3 and ANSI or TMDS 8b/10b encoding on channels 0-2.

In some embodiments, configuration, including the use of super-packets, is set via SCDC command messages. In some embodiments, super-packet mode is disabled on hot plug low or power down events in some embodiments, and/or is disabled in the transmitter via an SCDC transactions.

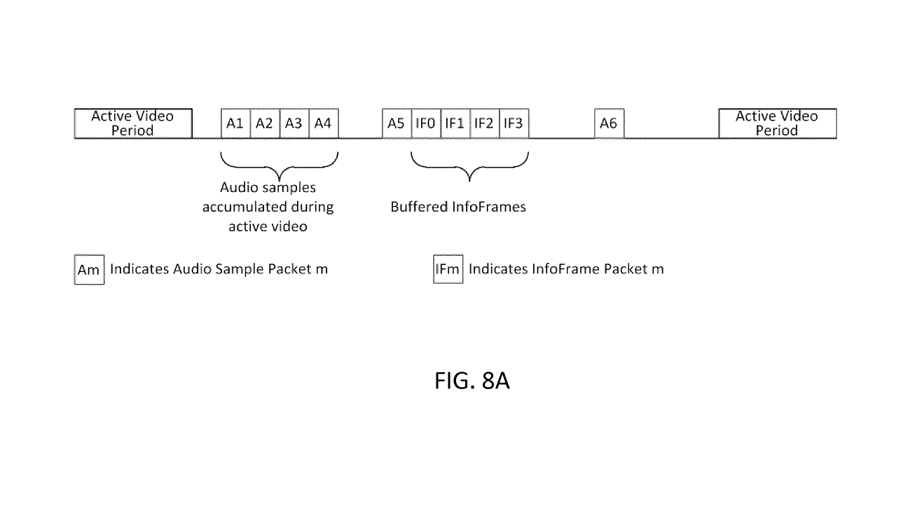

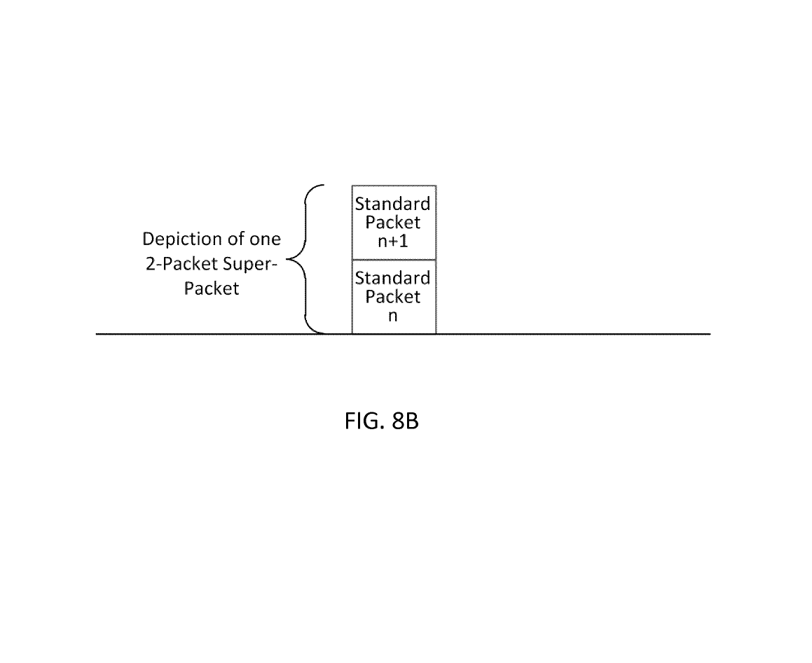

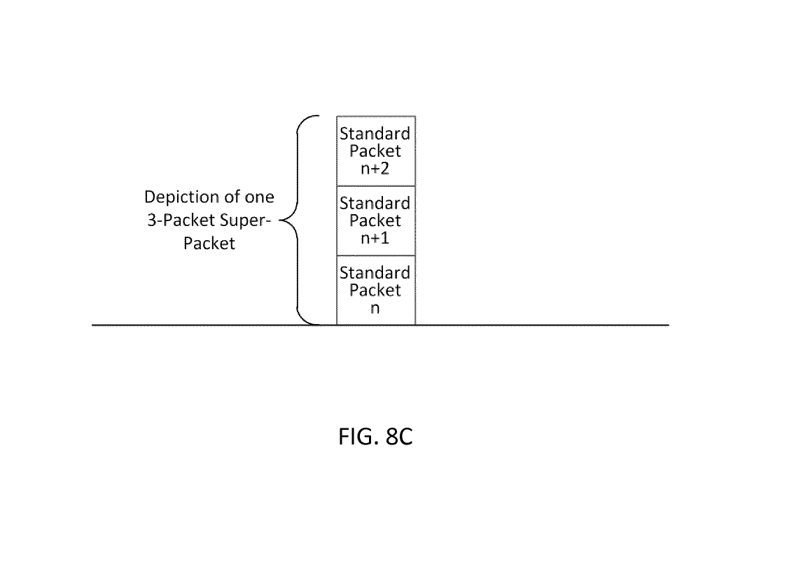

In some embodiments, super-packets can be implemented as 2-packet super-packets that load two standard packets into a single super packet, as shown in FIG. 8B. In some embodiments, super-packets can be implemented as 3-packet super packets that load two standard packets into a single super packet, as shown in FIG. 8C. Details about various structures of super-packets are described below with reference to FIGS. 8A-8C.

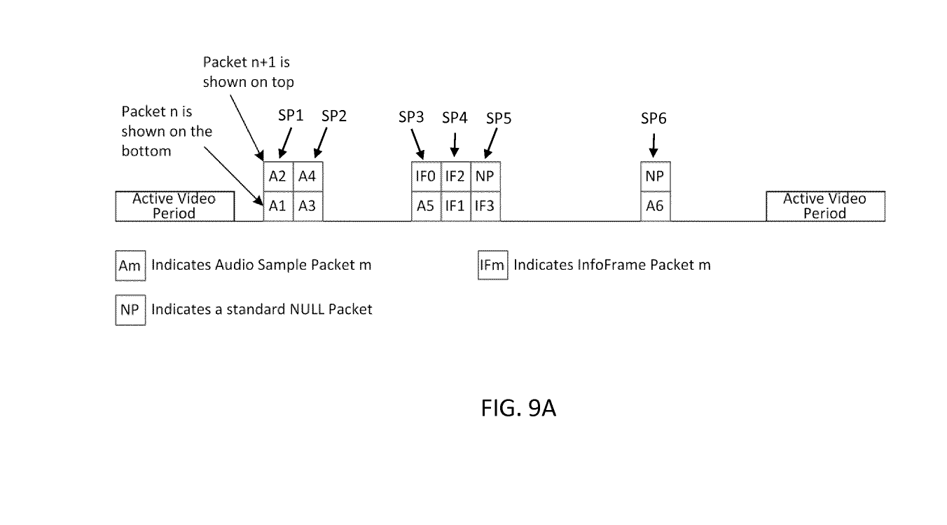

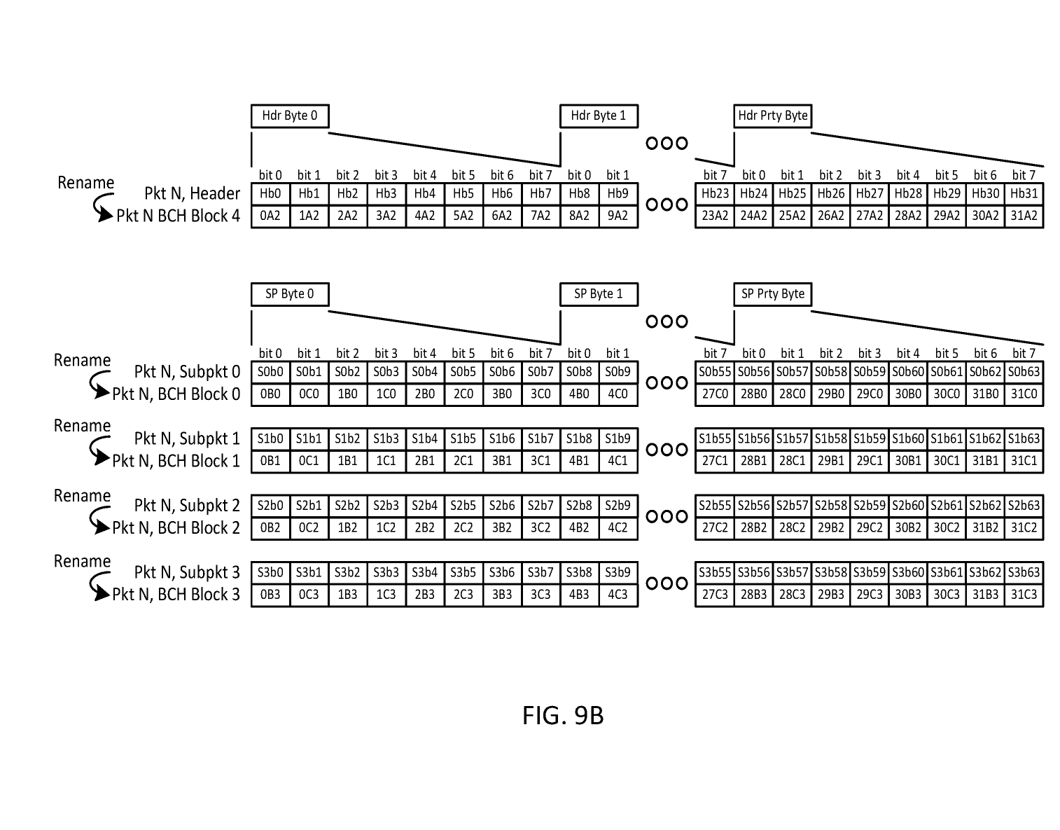

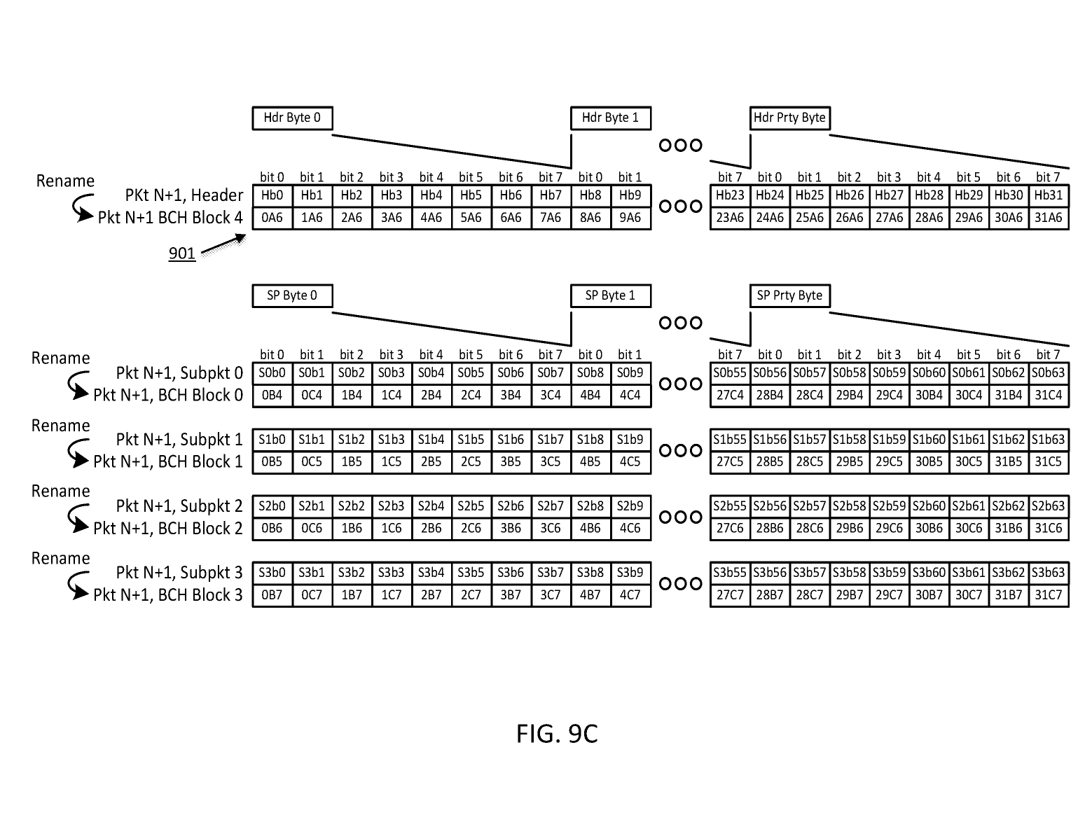

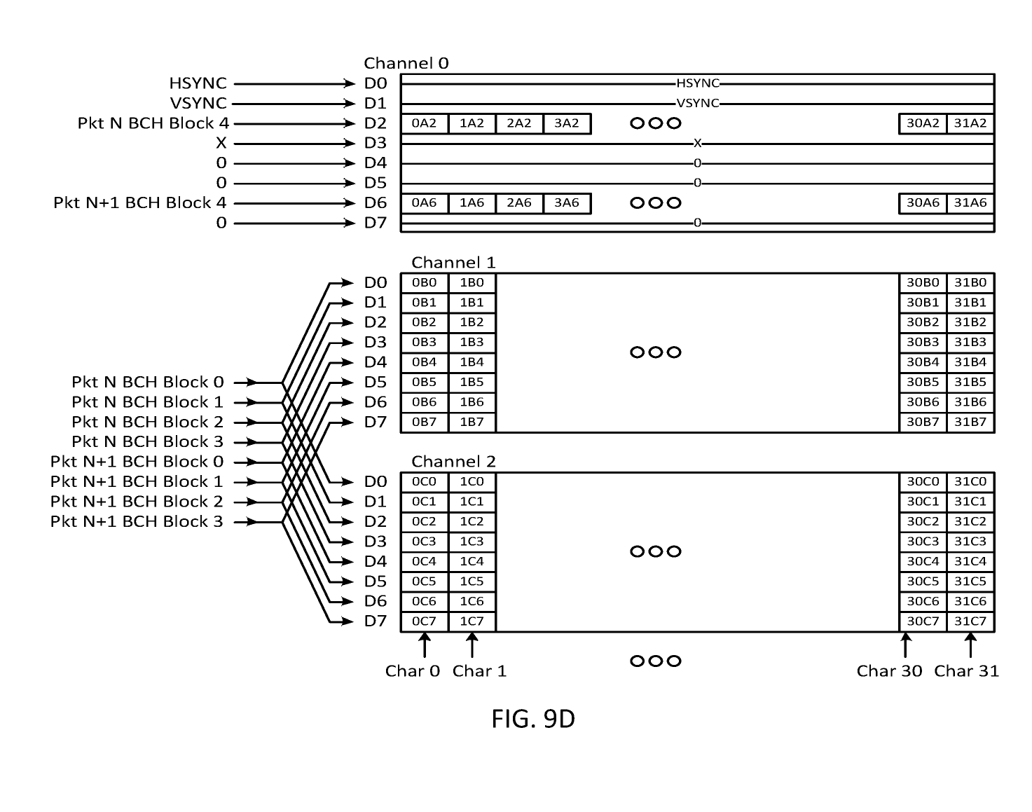

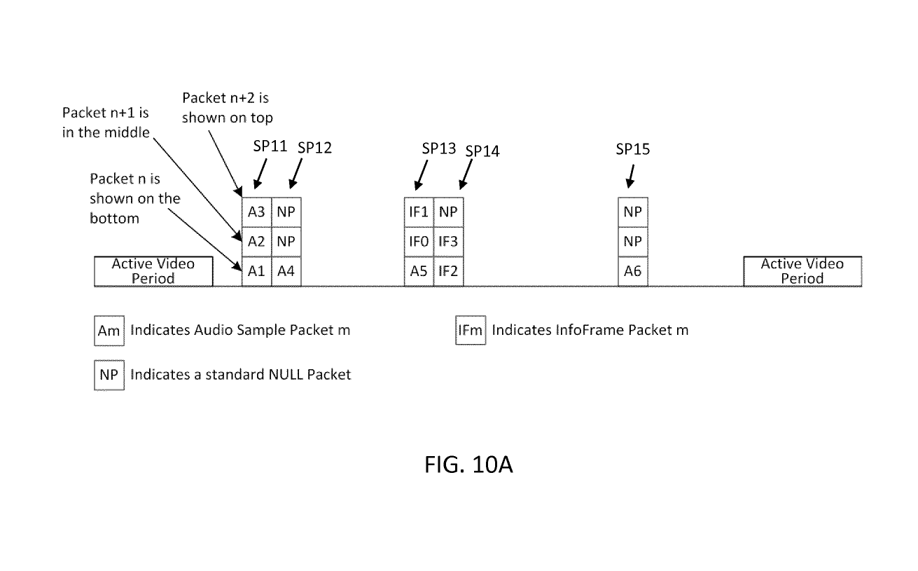

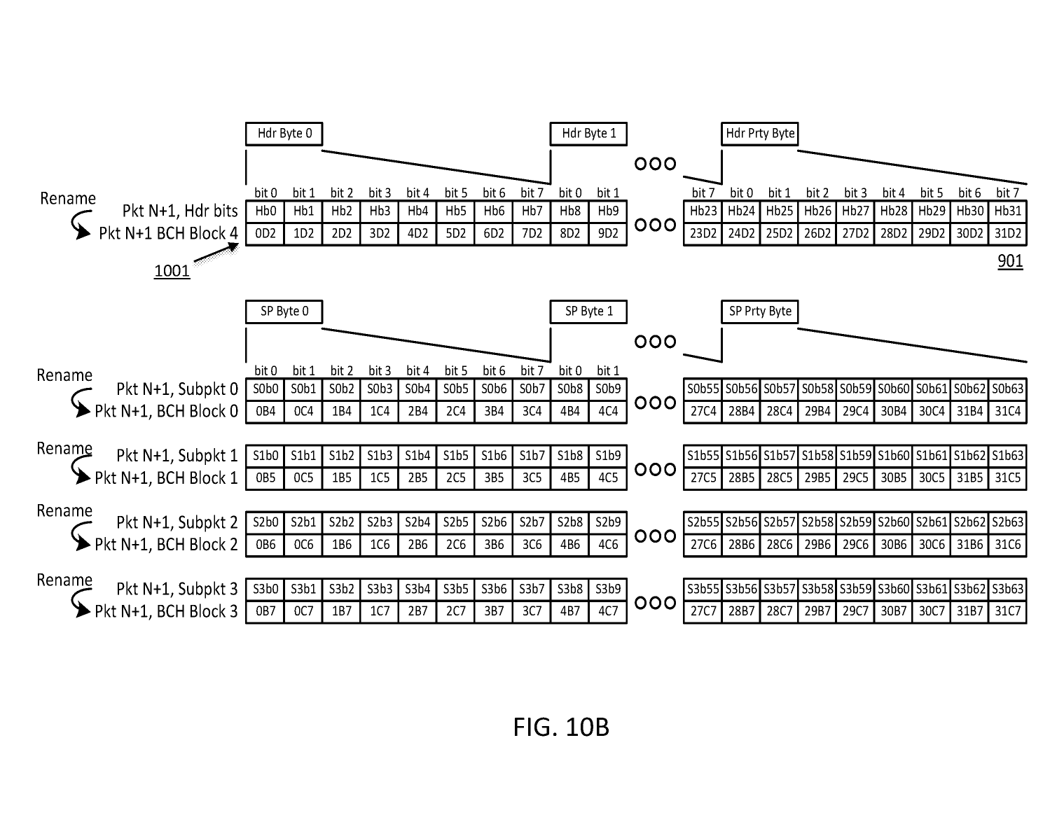

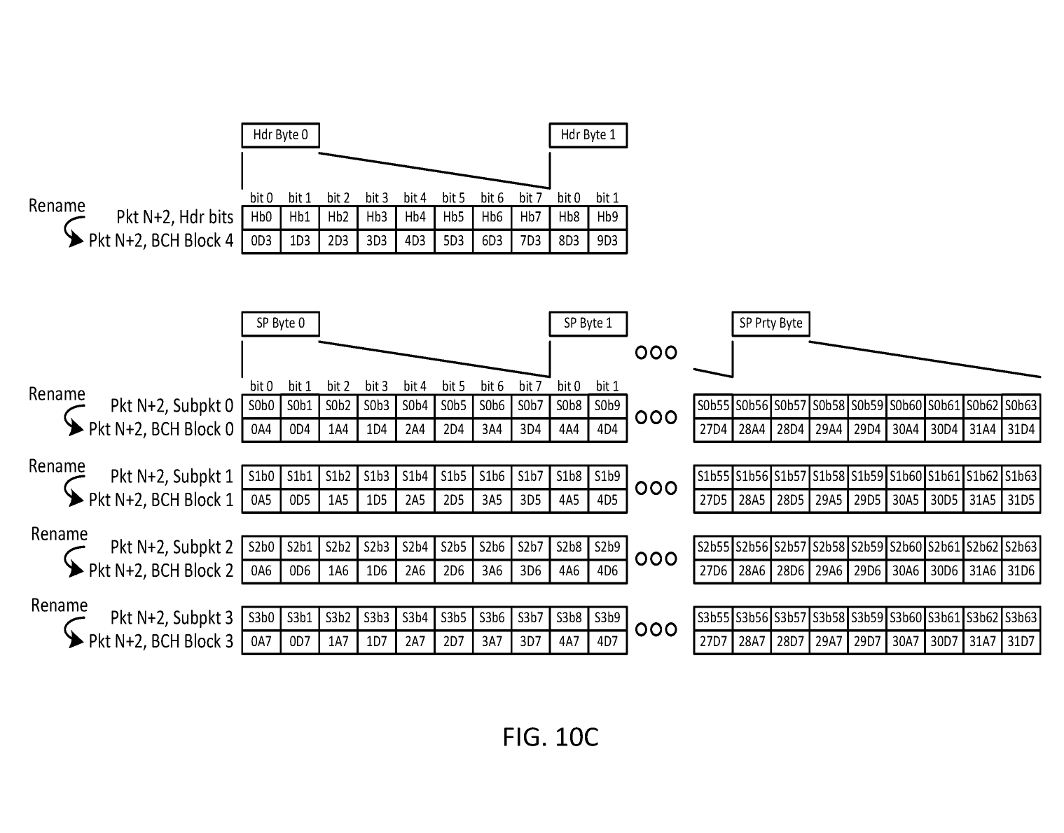

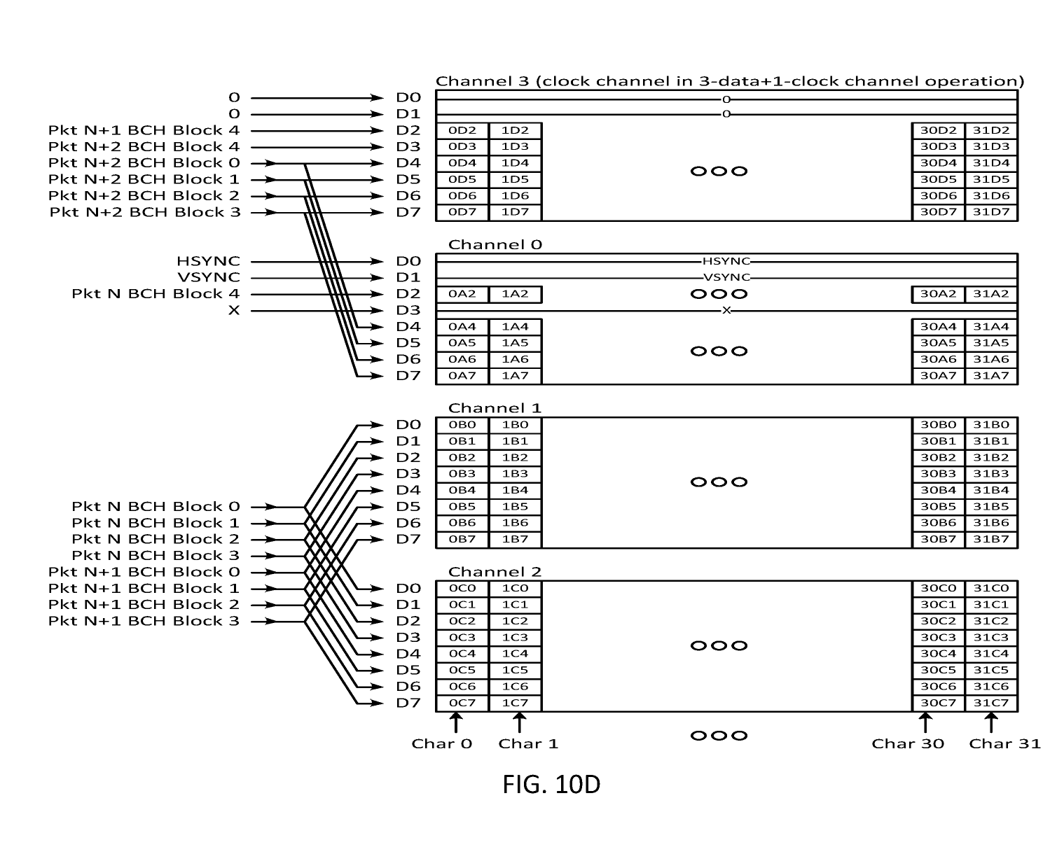

In some embodiments, standard packets are loaded in 2-packet super-packets in an arrangement shown in FIG. 9A. In some embodiments, standard packets are loaded in 2-packet super-packets by naming or renaming their bits as shown in FIGS. 9B and 9C. In some embodiments, standard packets are loaded in 3-packet super-packets in an arrangement shown in FIG. 10A. In some embodiments, standard packets are loaded in 3-packet super-packets by naming or renaming their bits as shown in FIGS. 10B and 10C. Details about various structures and methods for loading standard packets into super-packets are described below with reference to FIGS. 9A-9D and 10A-10D.

FIG. 2C is a diagram of mapping of BCH blocks to TMDS channels according to some embodiments, utilizing super-packets. As shown and in contradistinction to the embodiment shown in FIG. 1C, two packets (N and N+1) are transported in parallel. The header of packet N 220a is transmitted on channel 0, preencoded bit D2, with subpackets transported on channels 1 and 2 pre-encoded bits D0-D3 in some embodiments. Similarly, the header of Packet N+1 220b is transported on channel 0, pre-encoded bit D6, with subpackets transported on channels 1 and 2 pre-encoded bits D4-D7, in some embodiments. For each character transported, the value of HSYNC, VSYNC, and X may be the same in both Packet N 220a and Packet N+1 220b. In some embodiments, if there is no data for packet N+1 220b, the packet may be a null packet. Super-packets use the same data island preambles and guard bands as implementations of the HDMI specification in some embodiments. Super-packets support HDCP, with cipher bits applied to super-packets in the same manner as encoding video data, in some embodiments.

In some embodiments, as discussed above, TMDS channel 3 is used to transmit a third packet, as shown in the mapping diagram of FIG. 2D. In some embodiments, unused bits of channel 0 are also used to transmit the third packet and/or other data. In some embodiments, the bytes for the extra packet are all BCH protected in a manner similar to the BCH protection of header data in standard uncompressed packets. In some embodiments, channels 0 and 3 are interleaved in a similar manner to channels 1 and 2. Although this increases complexity, reliability is increased and error correction is improved according to some embodiments.

In some embodiments utilizing channel 3, coding of data on the channel is based on ANSI 8b/10b encoding. Video, island, and control periods are encoded with data (D) codes, while Guard Band periods are encoded with command (K) codes. In some embodiments, Island Lead Guard Bands consist of 2 K28.2 characters; Island Trail Guard Bands may consist of 2 K29.7 characters; Video Lead Guard Bands may consist of 2 K27.7 codes; and Video Trail Guard Bands consist of 2 K28.5 codes. These K code bands only apply to channel 3, with channels 0-2 utilizing TERC4 values for commands, in some embodiments. The K28.5 codes occupy the first 2 characters in the control period on channel 3, permitting proper alignment of preambles, in some embodiments. In some embodiments, Guard Bands are not scrambled. In some embodiments, preambles are not included on channel 3. Control Periods (periods without video, island, or guard band data) are set to 0 prior to scrambling in some embodiments.

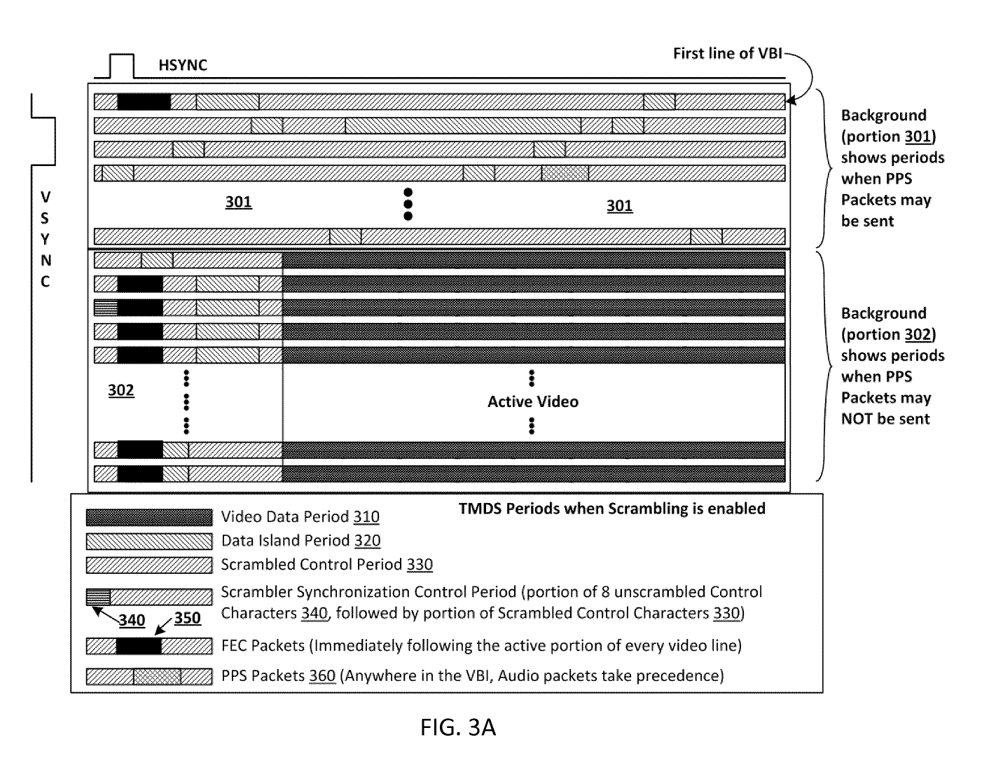

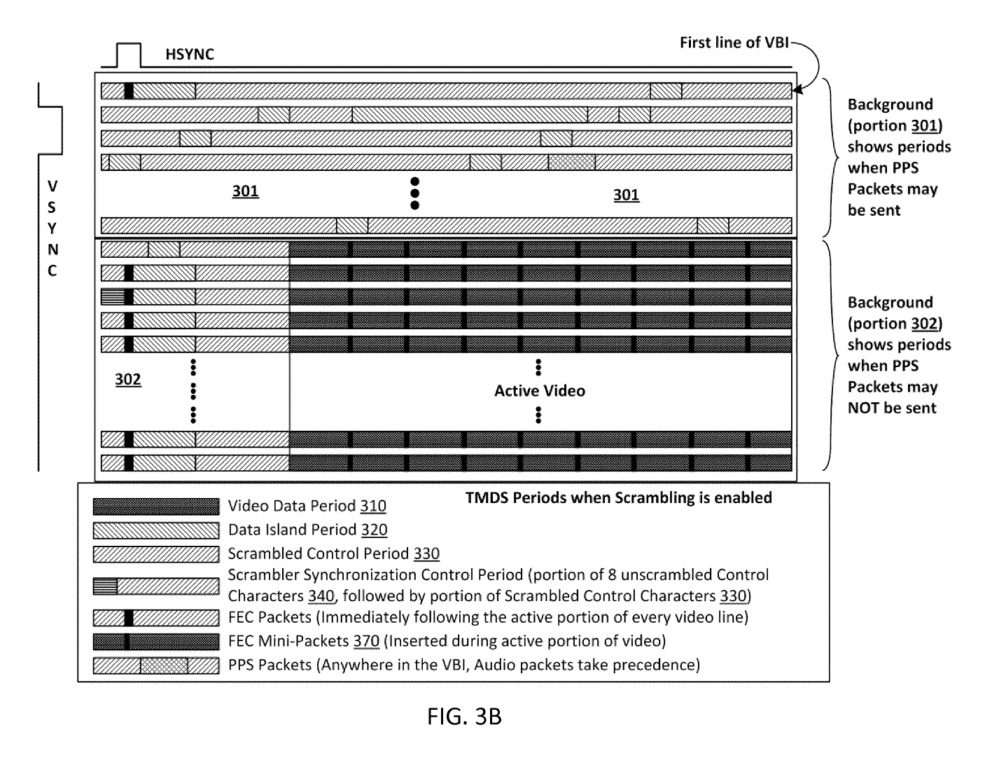

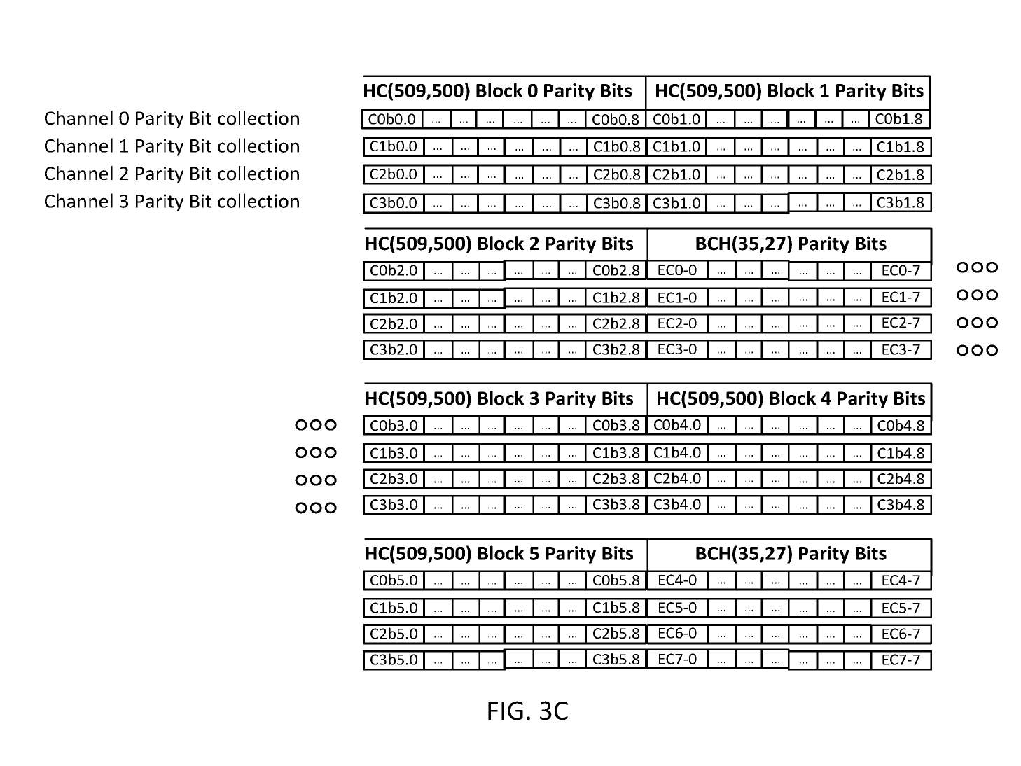

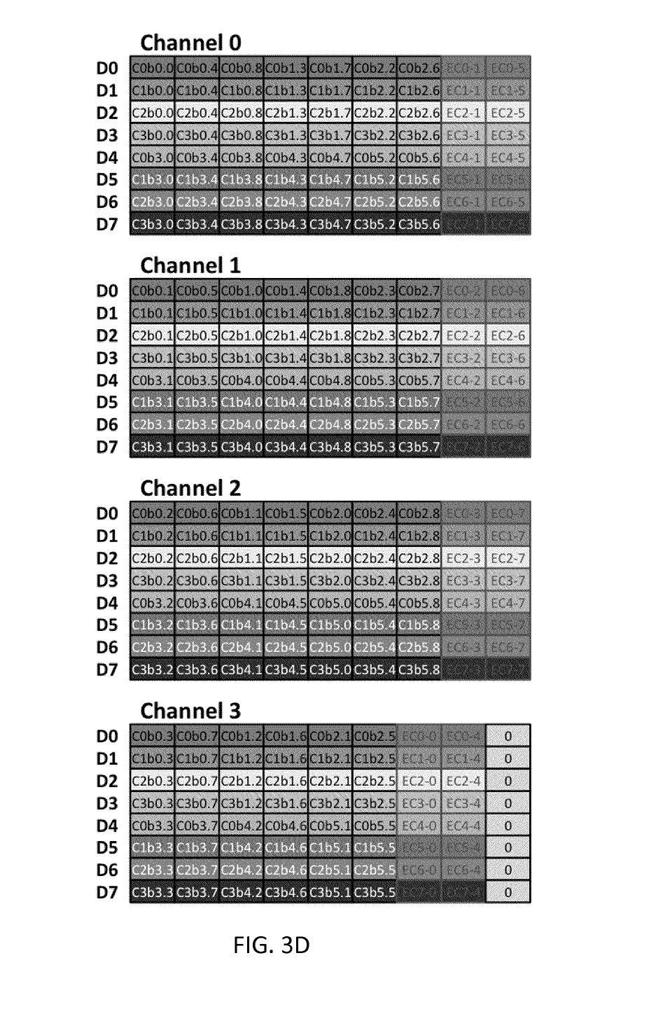

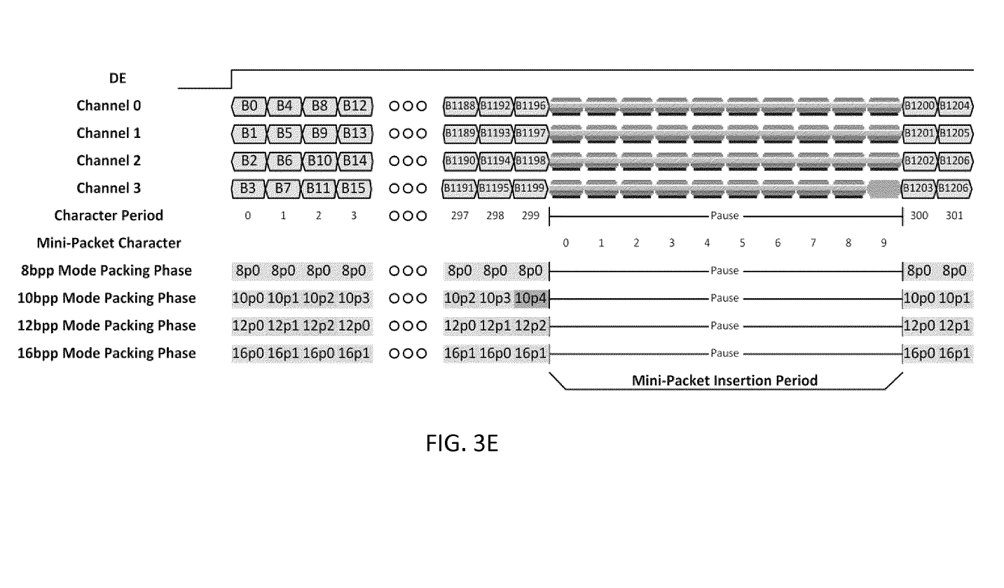

The unscrambled portion of the scrambler synchronization control period (SSCP), e.g. unscrambled control characters (e.g., portion of 8 unscrambled control character 340 in FIG. 3A), is encoded with a sequence of K30.7 codes, in some embodiments. If the SSCP immediately follows the Video Data, the SSCP is coded with a sequence of 6 K30.7 codes on channel 3, permitting the transmission of the trailing video guard band, in some embodiments. If the SSCP begins one character following the video data, the SSCP is coded with a sequence of 7 K30.7 codes on channel 3, in some embodiments. Conversely, if the SSCP begins two or more characters following the video data, the SSCP is coded with a sequence of 8 K30.7 codes on channel 3, in some embodiments. This provides protection of the SSCP even when the video trailing guard band overlaps the SSCP, in some embodiments. The unscrambled portion of the SSCP is not scrambled in some embodiments.

In some embodiments, Channel 3 is scrambled in a similar manner as Channels 0, 1, and 2, utilizing a similar linear feedback shift register (LFSR) function as that used for channels 0-2. In some embodiments, the seed value is 0xFFFC, and LN1 and LN0 in the control vector shall be encoded to 0b11. Video, Island, and Control Data are scrambled, while in some embodiments, Guard Bands and the unscrambled portion of the SSCP are left unscrambled.

In some embodiments, Channels 0, 1, and 2 are encoded in a manner similar to the encoding for Channel 3 described above, in some embodiments. For example, one or more of Channels 0-2 is also ANSI 8b/10b encoded in some embodiments.

In some embodiments as discussed above, three standard packets are transmitted in a single super-packet. The first two packets (e.g. packet N, N+1) are prepared in a similar method as shown in FIG. 2C and as discussed above. However, in some embodiments, packet N+1 BCH block 4 is moved to channel 3 bit D3, rather than channel 0 bit D6. This frees up bits D4-D7 of channel 0, which may be used for packet N+2. FIG. 2E is an illustration of mapping of BCH blocks in one such embodiment. As shown, channels 1 and 2 are similar to the embodiment of FIG. 2D. However, packet N+2 is interleaved between channels 3 and 0 on bits D4-D7 of each channel, similar to packet N+1 and channels 1 and 2. Block 4 of packet N+2 may be placed on bit D2 of Channel 3 as shown.

FIG. 2F is a diagram illustrating placement of DSC data in channels, according to some embodiments. As shown, in some embodiments, source video data 240 is provided to a DSC compression engine 242. DSC compression engine 242 may comprise a hardware compressor, such as an FPGA, ASIC, or SoC compressor, or is configured in software and executed by a processor. DSC compression engine 242 is configured to compress color components of a video signal according to one of a number of compression modes 248, including 8 bpp, 10 bpp, 12 bpp, or 16 bpp, in some embodiments. The compression engine 242 outputs a stream of bytes 244, which may be distributed across channel containers 246, in some embodiments. Regardless of deep color mode, the stream of bytes is divided across characters 250 according to some embodiments. For example, on average, 5 8-bit characters each are used to transmit each color component of 4 pixels in a 10 bpp mode in some embodiments. Each channel container 246 carries compressed video data with standard video timing, in some embodiments.

FIG. 3A is a diagram of placement of packets within a video frame, according to some embodiments. Blocks 330 represent scrambled control periods or periods in which data islands 320 may be placed. As shown and as discussed above, PPS packets 360 may be transmitted during the vertical blanking interval (portion 301). FEC blocks 350 may follow each line of active video data (blocks 310). As shown, no FEC block is transmitted before the first video line; similarly, the frame begins with an FEC block (upper left corner) corresponding to the last line of video of the previous frame.

In the embodiment shown in FIG. 3A, FEC blocks 350 are shown in a contiguous format. However, in some embodiments, FEC blocks 350 may be divided in a number of mini-packets 370, each carrying a subset of the FEC parity bits. FIG. 3B is another diagram of placements within a video frame, according to some embodiments. As shown in FIG. 3B, mini-packets 370 may be inserted during active video transmission periods. Such insertion may be periodic, such as every 3000 bits or every 300 characters. In some embodiments, mini-packets 370 may not include packet headers, allowing a reduced size. Inserting mini-packets into the video data correspondingly extends the length of each video line. This may result in a reduction of the length of the horizontal blanking intervals.

As discussed above, in some embodiments, an EDID or enhanced EDID (E-EDID) data structure is communicated via a display data channel for auto-discovery and configuration of devices compatible with the systems and methods discussed herein. In some embodiments, the E-EDID data structure includes a 1-bit flag or setting identifying whether the sink device supports super-packets. In some embodiments, the E-EDID data structure includes a 1-bit flag or setting identifying whether the sink device supports DSC compression. In some embodiments, the E-EDID data structure also includes a 16-bit string identifying the maximum slice width of a data slice; a string of bits identifying the supported DSC version; and/or any other type and form of configuration information.

Similarly, in some embodiments, the SCDC includes a 24-bit write only register indicating the nominal TMDS character rate in kHz; a 24-bit write only register indicating the nominal pixel rate in kHz; a 1 bit super-packet enabled control register; a 1 bit DSC-enabled control register; and/or any other such information.

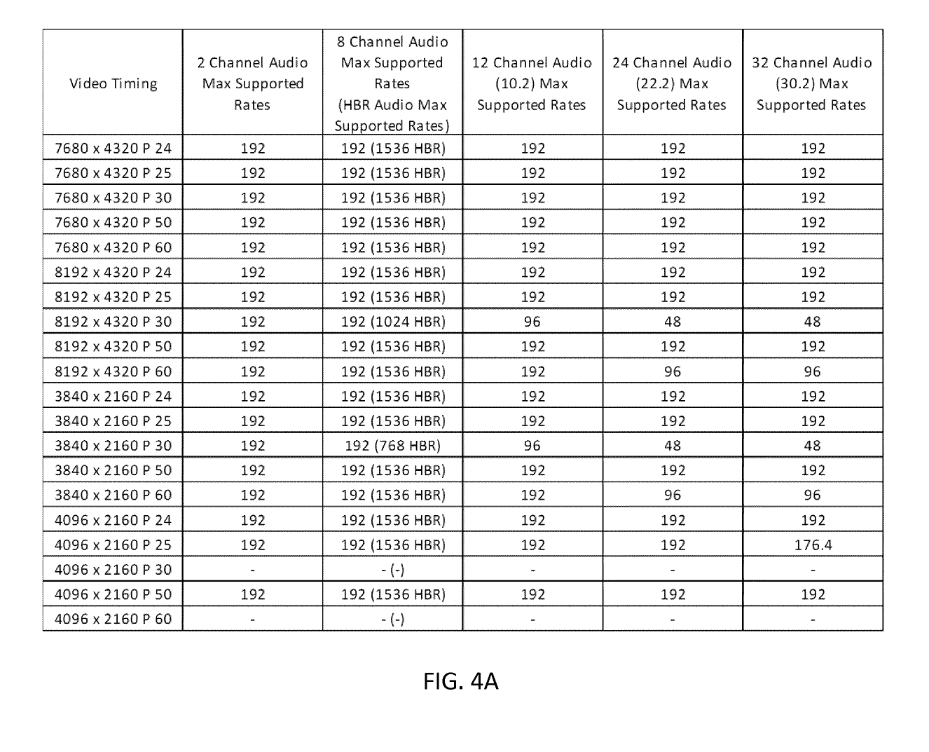

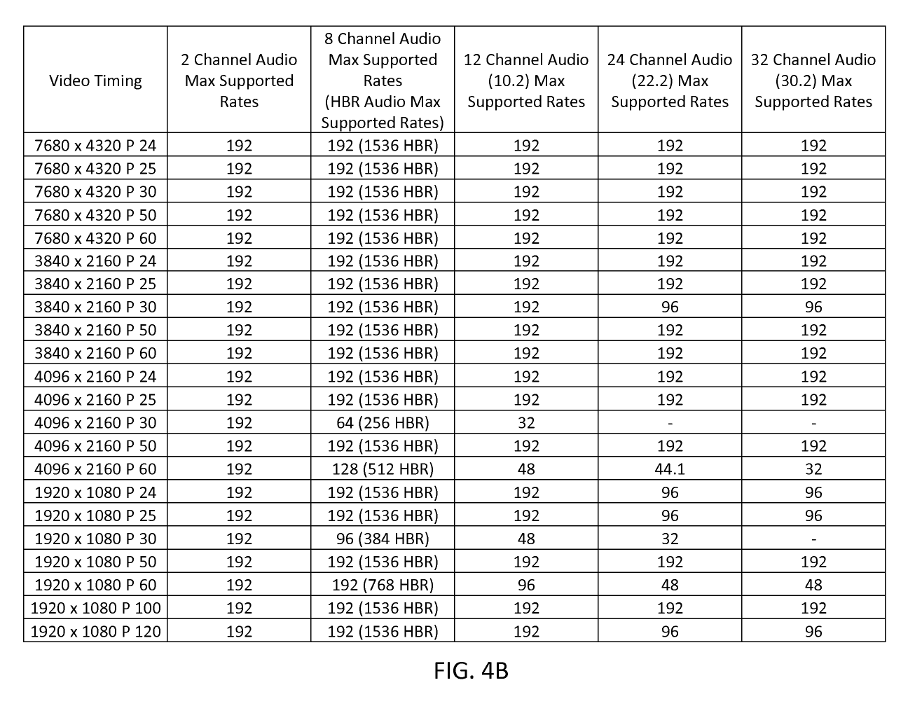

Referring briefly to FIG. 4A, illustrated is a chart of supported audio and video rates for the mapping of BCH blocks to TMDS channels shown in FIG. 2C, according to some embodiments. The example 8K video timings presented in FIG. 4A are derived by doubling the horizontal and vertical parameters of the 4K video standard timings. As shown, all but two of these timings support 2 Channel, 8 Channel, HBR, and 3D audio support at 192 kHz sample rate (1536 kHz for HBR). In the example 4 k×2 k timings illustrated, due to insufficient H blank periods, 4096×2160 P30 and P60 are not supported by DSC. All remaining 4 k×2 k video timings support at least 192 kHz audio sample rates for 2 channel and 8 channel audio, as well as providing good Support for 3D audio.

Similarly, FIG. 4B is a chart of supported audio and video rates for the mapping of BCH blocks to TMDS channels shown in FIGS. 2D-2E utilizing channel 3 for transmitting additional data, according to some embodiments. As shown in FIG. 4B, in some embodiments, the additional bandwidth provides 2 Channel, 8 channel, HBR, and 3D audio support at 192 kHz sample rate for all 8K timings; and at least 192 kHz audio sample rates for 2 channel audio for all 4K timings. Most 4K timings support 8 channel and HBR audio at max rates. 3D audio is also supported in some embodiments.

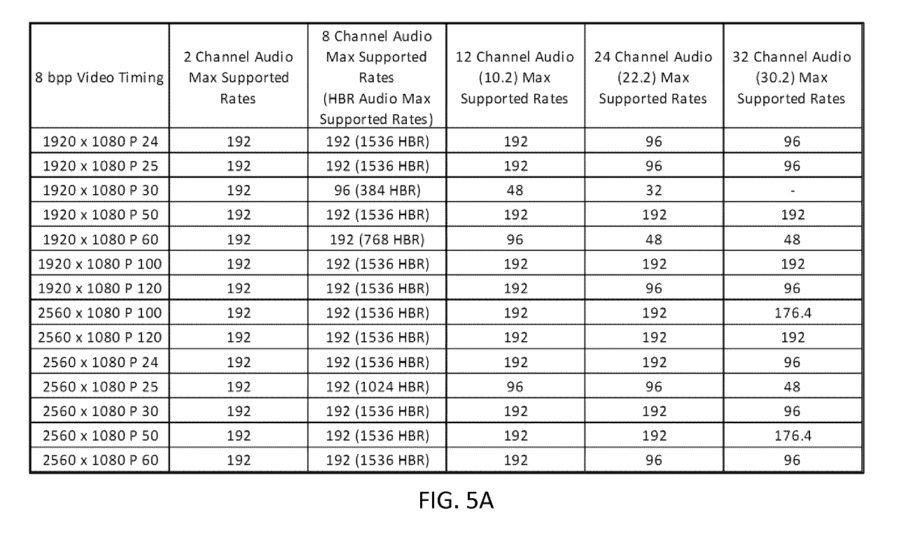

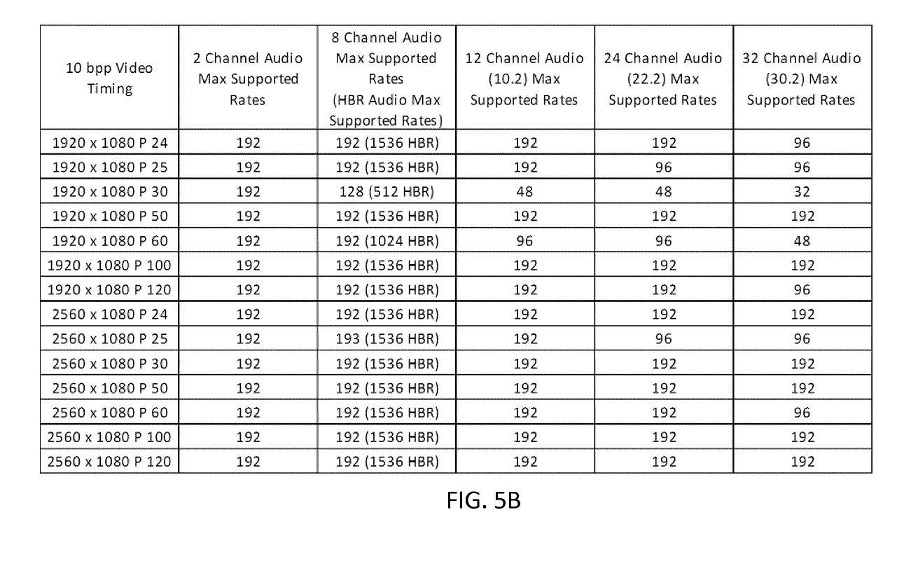

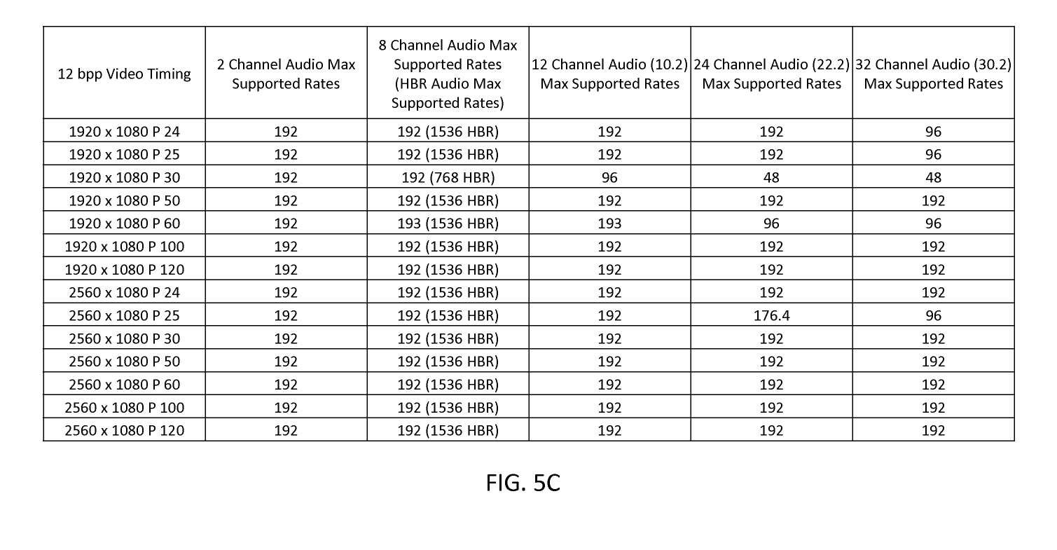

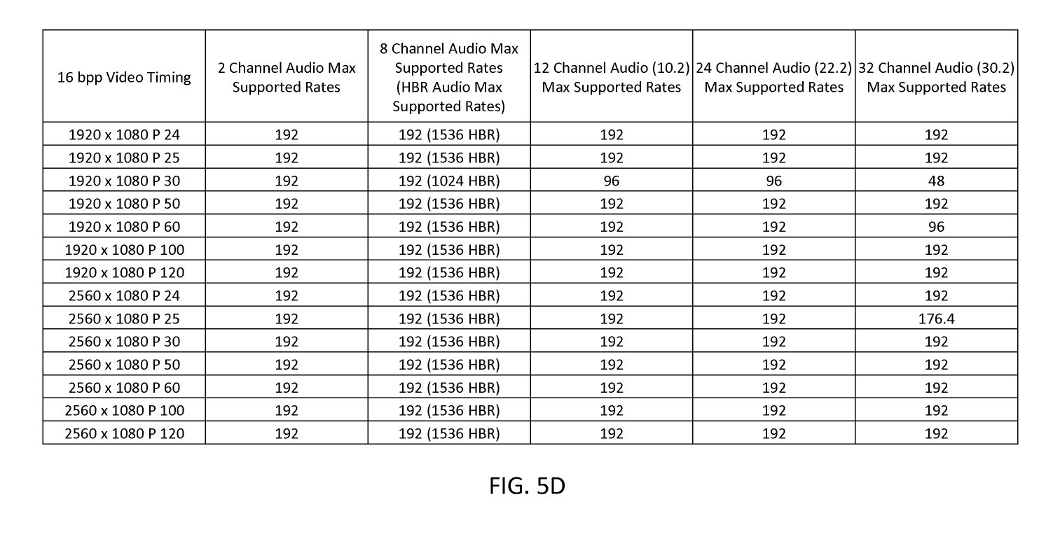

The charts of FIGS. 4A-4B summarize the audio capacity for several timings when 8 bpp compression is utilized. Similarly, FIGS. 5A-5D are charts of supported audio and 1080p video rates at additional compression rates for the mapping of BCH blocks to TMDS channels shown in FIGS. 2D-2E, according to some embodiments.

Accordingly, the systems and methods discussed herein provide for light compression and reconfiguration of TMDS channels through the use of TMDS coding islands to allow transmission of two packets or three packets per packet period, according to some embodiments.

In some embodiments, a packet injection mode is implemented to reduce latency. Specifically, in some embodiments, operational flows receive the entire Container Line before FEC error correction begins. For 8K video, this may use a 3840×40 or 4096×40 bit buffer (depending on which formats a vendor supports) in some embodiments. Accordingly, in some embodiments, packets or super-packets (if enabled) are injected directly into the active video portion of the container. This may reduce container line buffer requirements for FEC according to some embodiments. For example, if 3-packet super-packets are utilized, in some embodiments, this may reduce the buffering requirements by approximately a factor of four. If this mode is enabled and deep color DSC is active, in some embodiments, the phase rotation for the packet period continues as if the packet data were video data. In some embodiments, phrase rotators are paused while injected packets are being transmitted.

In some embodiments of packet injection, enough bits to fill a packet (or super-packets if enabled) are collected. The last TMDS character period that contributed to the packet is referred to as period “N”. In some embodiments, if a subsequent period, e.g. period N+41, is still within the active portion of the video (e.g. a trailing video guard band has not been encountered and character N+41 is not a video guard band character), then a packet (or super-packet if enabled) is inserted directly into the stream. In some embodiments, no Island framing structures (e.g. Preamble or guard bands) are sent before and/or after injection of the packet. In some embodiments, transmission of the compressed video pauses for a period, e.g. 32 clock cycles, while the packet is being sent. Conversely, if the subsequent period, e.g. period N+41, is not within the active portion of the video (e.g. a trailing video guard band has been encountered or Character N+41 is a video guard band character), in some embodiments, remaining parity bits are transmitted as standard packets (or super-packets if enabled) within Data Islands. Any remaining parity bits are transmitted with highest priority in the first Data Island, in some embodiments. Other durations are utilized for the subsequent measurement period, such as 14 character periods, 21 character periods, or any other such value, in some embodiments.

In some embodiments of packet injection, given an 8K compressed video with a container active period of 3840 characters; a 3 packets per super-packet case with 672 bits/super-packet; and using a Hamming(510,501) error correction coding system, the first container TMDS character following the video guard band is pixel 1. In some embodiments, after transmitting TMDS character period 940, the transmitter will have collected 675 bits. In some embodiments, 672 bits are loaded into a super-packet, and the remaining 3 bits are retained for the next super-packet. The super-packet are then transmitted on TMDS characters 981-1012, and transmission of active video may resume on clock 1013, in some embodiments. Similarly, after transmitting TMDS character period 1911, the transmitter will have collected 678 bits pending transmission, in some embodiments. 672 bits will be loaded into a super-packet, and the remaining 6 may be retained for the next super-packet, in some embodiments. In some embodiments, the super-packet is transmitted on TMDS characters 1952-1983, and transmission of active video resumes on clock 1984. After transmitting TMDS character period 2806, in some embodiments, the transmitter will have collected 672 bits pending transmission. In some embodiments, 672 bits are loaded into a super-packet, and there are no remaining bits to be retained for the next super-packet. In some embodiments, the super-packet is transmitted on TMDS characters 2911-2942, and transmission of active video will resume on clock 2943. After transmitting TMDS character period 3841, in some embodiments, the transmitter will have collected 675 bits pending transmission. In some embodiments, as with the first super-packet, 672 bits are loaded into a super-packet, and the remaining 3 bits are retained for the next super-packet. The super-packet is transmitted on TMDS characters 3882-3913, with transmission of active video resuming on clock 3914, in some embodiments. Finally, after transmitting TMDS character period 3968, in some embodiments, the transmitter will have transmitted the entire container line. As the line is finished, there are still 66 parity bits pending transmission, and 294 bits that still require HC protection, in some embodiments. These may be zero padded out to 501 bits by adding 207 zeroes to the block, and parity may be regenerated (resulting in 9 additional parity bits, or a total of 75 parity bits that still need to be sent). In some embodiments, the remaining parity bits, e.g. 75 bits, are packaged up into a single packet and sent during the first packet slot in the next Data Island. Accordingly, under such an embodiment and as shown in FIG. 3A, in some embodiments, error correction is sent shortly after each block of data, reducing latency and buffer requirements.

In some embodiments using mini-packets, as shown in FIG. 3B, error correction is transmitted embedded within each line of video data. In some embodiments, a Hamming(509,500) code is employed, correcting 1 bit of error per 509-bit block. For example, given a 7680 pixel per video line input and the 2 input line per container line methodology discussed above in connection with FIG. 2B, each line corresponds to 153,600 bits after encoding, in some embodiments. Employing HC(509,500) results in 308 HC blocks required per container line carrying 2772 FEC parity bits, in some embodiments. This may be divided into 12 mini-packets (transporting 2592 bits) embedded in the video data and one FEC packet (transporting 180 bits) in the subsequent blanking interval, in some embodiments. FEC parity data is collected on a per channel basis as the data is encoded and transmitted, and embedded in the data to reduce latency and buffer requirements, in some embodiments. In some embodiments, a Reed Solomon Code, for example RS(8,9), can be used to correct bit errors.

In some embodiments, each mini-packet includes FEC parity data. Each mini-packet does not include a header in some embodiments. Each mini-packet includes 24 9-bit parity words divided across 8 sub-mini-packets, each comprising 3 HC(509,500) words, in some embodiments. Sub-mini-packets utilize BCH encoding similar to BCH(128,120) used for standard packets and subpackets, albeit at a smaller size, in some embodiments. For example, in some embodiments, sub-minipackets are encoded with BCH(128,120) shortened to BCH(35,27) coding.

As discussed above in connection with FIG. 3B, in some embodiments, mini-packets are inserted periodically into video data, such as once every 300 character periods. FIG. 3C is a diagram illustrating collection of parity bits from HC(509,500) data blocks and generation of BCH(35,27) parity bits. As shown in FIG. 3C, in some embodiments, three blocks of HC parity data are received from an encoder and BCH(35, 27) parity bits calculated and concatenated to the HC parity data. Two groups of data are generated as shown for transmission, in some embodiments. As shown in FIG. 3D, in some embodiments, the parity data is divided over the four TMDS channels and transmitted in parallel. As shown in FIG. 3D, in the last bits on channel 3, in some embodiments, the data may be zero-padded. In some embodiments, the padding includes an identification code, such as an identifier of the position of parity injection within the video line. Although shown at the end of the transmission on channel 3 in FIG. 3D, in some embodiments, such padding or identification code is placed in the first byte or any other predetermined position, and/or on another channel.

In some embodiments, as discussed above, additional parity data exists that does not fit in the existing mini-packets. For example, in some embodiments, given an 8K video with 7680 pixels per line or 3840 characters, 12 mini-packets are inserted in the data every 300 characters. In some embodiments, these mini-packets carry 2592 bits of the total 2770 parity bits. In some embodiments, the remaining 180 bits are included (with zero-padding or the inclusion of identification codes or other data if necessary) in a super-packet transmitted at the end of the container line.

In embodiments in which 10 bpp, 12 bpp, or 16 bpp deep color modes are utilized, the color phase is carried across the mini-packet transmission interval, without incrementing the phase. For example, referring to FIG. 3E, illustrated is a diagram of some embodiments of mini-packet insertion within a video line. In some embodiments, following character 299 of the video data, the mini-packet is transmitted as shown in FIG. 3E. Color phase for each of the deep color modes is paused during this period, in some embodiments. In some embodiments, color phase synchronizes with the periodic insertion of mini-packets, such that the first subsequent character (e.g. characters 300, 600, 900, etc.) is at the initial color phase as shown in FIG. 3E.

In some embodiments, the total bandwidth in container active and blank periods can be increased by adapting existing deep color modes, thereby providing more bandwidth available for audio transport and for increased compressed bits per pixel (bpp) settings. In some embodiments, in the context of compression, deep color modes may provide increased compressed bits per pixel, while the standard deep color may increase the bits per component.

FIG. 6A is a diagram showing a mapping from a video timing to a video container, according to some embodiments. In some embodiments, when a compressed video is being transported, a video container timing (or container timing) is defined for the use of the transport of the compressed video stream. In some embodiments, HDMI constructs and methodologies, for example, placement of Guard Bands, Data Islands, preambles, or any cryptography controls (e.g. HDCP 1.4 frame rekey), utilize container timings in place of video timings when compressed video is being transported.

In some embodiments, container timings are defined in terms of video format timings (or video timings). Referring to FIG. 6A, the video format timings may include Vertical Front Lines (Vfront), Vertical Back Lines (Vback), Vertical Blanking Lines (Vblank), Vertical Active Lines (Vactive), Horizontal Front Pixels (Hfront), Horizontal Sync Pulses (Hsyinc), Horizontal Blank Pixels (Hblank), Horizontal Active Pixels (Hactive), etc. In some embodiments, container timings contain an active portion that is similar to a video timing picture. Referring to FIG. 6A, in some embodiments, container timings have Horizontal Container Active Pixels (HCactive) and Vertical Container Active Lines (VCactive) which are similar to Hactive and Vactive, respectively. In some embodiments, container timings have blanking periods defined as a function of underlying video timings. For example, Horizontal Container Blank Pixels (HCblank) are similar to Hblank and Vertical Container Blanking Lines (VCblank) are similar to Vblank.

In some embodiments, container timing parameters can be computed as follows:

HCactive=Hactive/2 (Equation 1),

VCactive=Vactive/2 (Equation 2),

HCblank=Hblank/2 (Equation 3),

Average Vertical Container Blanking Lines (VCblankAverage)=Vblank/2 (Equation 4).

In some embodiments, no signal similar to Hsync signals is transmitted as part of a video container (i.e. when compression is active). In some embodiments, the Hsync signal in the HDMI interface is set to 0 when compression is active. In some embodiments, a Virtual Compressed Hsync Front Porch (HCfrontvirtual) is computed based on the video timing Hfront. In some embodiments, HCfrontvirtual is not be transmitted, but is used as a reference for placement of the Container VSYNC pulse (VCsync). In some embodiments, HCfrontvirtual is computed as follows:

HCfrontvirtual=Ceiling(Hfront/2) (Equation 5).

In some embodiments, a modified Vsync pulse, i.e., Container Vsync pulse (VCsync), is transmitted as part of a video container (i.e. when compression is active). In some embodiments, the video timings Vfront, Vsync, and Vback are modified to create the VCfront, VCsync, and VCback parameters, respectively. In some embodiments, VCback alternates between two values, VCback[0] and VCback[1]. In some embodiments, when the underlying video timing has an odd number of total lines per frame, the two values VCback[0] and VCback[1] are different. In some embodiments, when the underlying video timing has an even number of total lines per frame, the two values VCback[0] and VCback[1] are the same.

In some embodiments, VCfront, VCsync, VCback[0], and VCback[1] can be computed as follows:

VCfront=Ceiling(Vfront/2) (Equation 6),

VCsync=Ceiling(Vsync/2) (Equation 7),

VCback[0]=Floor((Vfront+Vsync+Vback)/2)−(VCfront+VCsync) (Equation 8),

VCback[1]=Ceiling((Vfront+Vsync+Vback)/2)−(VCfront+VCsync) (Equation 9),

VCbackAverage=(VCback[0]+VCback[1])/2, (Equation 10),

VCblankAverage=VCfront+VCsync+VCbackAverage=Vblank/2. (Equation 11).

In some embodiments, the VCSync signal can make transition to high or low at the same instant the HCfrontvirtual lead edge occurs. In some embodiments, the polarity of VCsync is the same as the polarity of the video timing Vsync used to generate the container timing. In some embodiments, the video timing defines fVideo_Timing as Pixel Clock Rate, and the container “pixel” rate can be computed as follows:

fContainer_pixel=fVideo_Timing/4 (Equation 12).

FIG. 6B is a chart of some example container timings, according to some embodiments. In some embodiments, when a container timing is defined, the next step is to load compressed video data into the container. In some embodiments, the Video Electronics Standards Association Display Stream Compression (VESA DSC) 1.1 uses the term “chunk” to refer to compressed video data. In some embodiments, a chunk is a block of output data that corresponds to an uncompressed slice. In some embodiments, the number of bytes in a chunk is fixed, but due to the nature of compression, a chunk contains data from one or more video lines. An example of loading chunks into a video container is depicted in FIG. 2B.

In some embodiments, the next step is to load data bytes onto active channels. An example of loading data bytes onto active channels is illustrated in FIG. 2F.

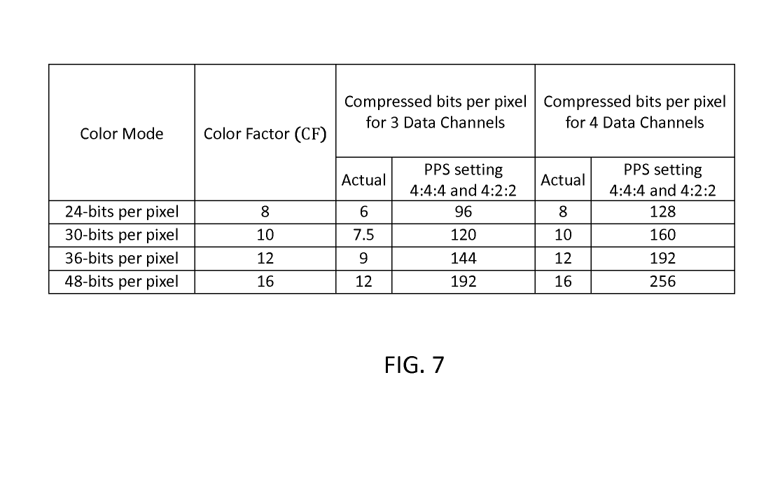

FIG. 7 is a chart of a configuration of picture parameter set (PPS) syntax elements and corresponding compressed bits per pixels (bpps), according to some embodiments. In some embodiments, as shown in Equation 13, the (actual) compressed bpp is computed as a function of the number of channels (channels) that are active and the color factor (CF). In some embodiment, the color factor is a color depth. In some embodiments, the (actual) compressed bpp is computed as follows:

bpp_{compressed}=2*(CF/8)*channels (Equation 13).

For example, referring to FIG. 7, for the 24-bits per pixel color mode, the (actual) compressed bpp for 3 data channels is 6, and the (actual) compressed bpp for 4 data channels is 8.

In some embodiments, a 4:4:4 or 4:2:2 chroma subsampled stream can be utilized. For example, referring to FIG. 7, when a 24-bit 4:4:4 or 4:2:2 chroma subsampled stream is used, the compressed bpp for 3 data channels is 96 (referred to compressed bpp 701 in FIG. 7), and the compressed bpp for 4 data channels is 128. In some embodiments, when a 30-bit 4:4:4 or 4:2:2 chroma subsampled stream is used, the compressed bpp for 3 data channels is 120, and the compressed bpp for 4 data channels is 160. In some embodiments, some compressed bpps (e.g., 96 compressed bpps when 24-bit 4:4:4 or 4:2:2 chroma subsampled stream is used for 3 data channels) are visually lossless for most content. In some embodiments, some compressed bpps (e.g., 120 compressed bpps when 30-bit 4:4:4 or 4:2:2 chroma subsampled stream is used for 3 data channels) are visually lossless except for worst-case patterns.

In some embodiments, video containers for 3D video are computed in the same manner as for 2D video. In this case, a 3D structure may be used instead of the video timing to generate the corresponding video container as described in the embodiments of FIGS. 6A-6B.

FIG. 8A is a diagram of an example of standard packet transmission, according to some embodiments. For example, referring to FIG. 8A, following a first active video period, standard packets can be transmited in the order of audio sample packets (A1-A4) accumulated during the first active video period, an audio sample packet A5, buffered InfoFrame packets IF0-IF3, and an audio sample packet A6, followed by another active video period.

FIG. 8B is a diagram of an example of 2-packet super-packets, according to some embodiments. FIG. 8C is a diagram of an example of 3-packet super-packets, according to some embodiments. In some embodiments, an option to permit more efficient transport of standard packet data is provided by using a packet structure referred to as super-packets. In some embodiments, two variants of super packets are defined: 2 packet super-packets and 3 packet super-packets. For example, sources may transmit 2-packet super-packets on links operating with 3 data channels. In some embodiments, source devices do not transmit 2-packet super-packets when the link is operating with 4 data channels. In some embodiments, sources may transmit 3-packet super-packets on links operating with 4 data channels.

Referring to FIG. 8B, which shows an example of 2-packet super-packets, in some embodiments, each 2-packet super-packet carries two standard packets, e.g., standard packet n and standard packet (n+1). In some embodiments, such 2-packet super-packet is implemented by TMDS encoding the packet data rather than the TERC4 encoding used for standard packets. In some embodiments, 8 bits of packet data is encoded into each 10 bit symbol, thereby effectively doubling the available throughput for Data Island Packet Data. In some embodiment, the ordering of standard packets (e.g., the ordering shown in FIG. 8A) as they are loaded in the 2-packet super-packets is maintained. For example, the standard packets as shown in FIG. 8A may be grouped into 2-packet super-packets as shown in FIG. 9A. FIG. 8B shows two standard packets stacked vertically to form a single 2-packet super-packet. In some embodiments, the lower packet is the one that would be transmitted first when using standard packet transmission, and the upper packet is the one that would immediately follow.

In some embodiments, not only audio packets but also Adaptive Clock Recovery (ACR) packets may be transported using 2-packet super-packet, thereby transporting both audio packets and ACR packets when super-packet transmission is active. In some embodiments, a single packet is available for transmission when no other packet data needs to be transported. In this case, the delivery of the packet may not be delayed, in some embodiments. Instead, the packet may be inserted into position “n” and a Null packet may be inserted into position “n+1” of the 2-packet super-packet, in some embodiments. In some embodiments, packet position “n” is not be populated with a Null packet unless packet “n+1” contains a Null packet. In some embodiments, it is permissible to load 2 Null packets into a 2-packet super-packet.

Referring to FIG. 8C, which shows an example of 3-packet super-packets, in some embodiments, each 3-packet super-packet carries three standard packets, e.g., standard Packet n, standard packet (n+1) and standard packet (n+2). In some embodiments, such 3-packet super-packet is implemented by TMDS encoding the packet data rather than the TERC4 encoding used for standard packets and repurposing the clock channel as occurs when an advanced encoding (AE) mode is active. In some embodiments, 8 bits of packet data are encoded into each 10 bit symbol, thereby tripling the available throughput for Data Island Packet Data, with the additional channel to transport data. In some embodiments, the ordering of standard packets (e.g., the ordering as shown in FIG. 8A) as they are loaded in the 3-packet super-packets is maintained. That is, a sequence as depicted in FIG. 8A may be transmitted with 2-packet or 3-packet super-packets.

For example, the standard packets from FIG. 8A can be grouped into 3-packet super-packets as depicted in FIG. 8C. FIG. 8C shows three standard packets stacked vertically to form a single 3-packet super-packet. In some embodiments, referring to FIG. 8C, the lowest packet (standard packet “n”) is the one that would be transmitted first when using standard packet transmission, the middle packet (standard packet “n+1”) is the one that would immediately follow, and the top packet (standard packet “n+2”) follows the middle one.

In some embodiments, not only audio packets but also Adaptive Clock Recovery (ACR) packets may be transported using 3-packet super-packet, thereby transporting both audio packets and ACR packets when super-packet transmission is active.

In some embodiments, a single packet is available for transmission when no other packet data needs to be transported. In this case, the delivery of the single packet may not be delayed, in some embodiments. The packet may be inserted into position “n” and Null Packets may be inserted into position “n+1” and position “n+2” of the 3-packet super-packet, in some embodiments.

In some embodiments, two packets are available for transmission when no other packet data needs to be transported. In this case, the delivery of the two packets may not be delayed, in some embodiments. The first packet in time may be inserted into position “n”, the second packet in time may be inserted into position “n+1”, and a Null packet may be inserted into position “n +2” of the 3-packet super-packet, in some embodiments.

In some embodiments, packet position “n” is not populated with a Null packet unless packet “n+1” and packet “n+2” contains a Null Packet. In some embodiments, packet position “n+1” is not populated with a Null packet unless packet “n+2” contains a Null packet. In some embodiment, it is permissible to load 3 Null packets into a 3-packet super-packet.

FIG. 9A is a diagram of an example of standard packets loaded into 2-packet super-packets, according to some embodiments. FIG. 9A depicts an exemple of transmitting the packets shown in FIG. 8A using 2-packet super-packets. Referring to FIG. 9A, following a first active video period, 2-packet super-packets can be transmited in the order of a first super-packet SP1 with the audio sample packets A1 and A2 loaded on the bottom and top thereof, respectively, a second super-packet SP2 loaded with the audio sample packets A3 and A4 on the bottom and top thereof, respectively, a third super-packet SP3 loaded with the audio sample packet A5 and the InfoFrame packet IF0 on the bottom and top thereof, respectively, a fourth super-packet SP4 loaded with the InfoFrame packets IF1 and IF2 on the bottom and top thereof, a fifth super-packet SP5 loaded with the InfoFrame packet IF3 and a Null packet on the bottom and top thereof, respectively, and a sixth super-packet SP6 loaded with the audio sample packet A6 and a Null packet on the bottom and top thereof, respectively, followed by another active video period.

In some embodiments, minor variations in the grouping of these packets and the addition of Null Packets are permissible. In some embodiments, the order of the standard packets (e.g., A1, A2, A3, A4, A5, IF0, IF1, IF2, IF3, A6) as shown in FIG. 8A is preserved while minor variations in the grouping of these packets and the addition of Null Packets are permissible.

FIG. 9B is a diagram of an example of naming (or renaming) bits for subpacket n for loading into a 2-packet super-packet and 3-packet super-packet, according to some embodiments. In some embodiments, the loading of the 2-packet super-packet is specified in terms of BCH blocks. An examplary naming of the bits for subpacket “n” using BCH block lables according to some embodiments is summarized in FIG. 9B.

In some embodiments, the BCH block labels take the form [Num1][AlphaChar][Num2], where [Num1] indicates a character position on which the bit will reside in a 32 character long packet, [AlphaChar] indicates a channel on which the bit will be carried, and [Num2] indicates a bit position on which the bit will reside on an un-encoded/post-decoded 8-bit word. In some embodiments, [Num2] can have a value “A”, “B” or “C”, which indicate “channel 0,” “channel 1,” and “channel 2,” respectively. For example, the BCH block label “0B2” refers to character 0, channel 1, and bit position 2 in an un-encoded/post-decoded character, in some embodiments.

FIG. 9C is a diagram of an example of naming (or renaming) bits for subpacket “n+1” for loading into a 2-packet super-packet, according to some embodiments. In some embodiments, the same definition of the BCH block labels as used in FIG. 9B, is used in naming bits for subpacket “n+1” for loading into a 2-packet super-packet. An examplary naming of the bits for subpacket “n+1” using BCH block lables according to some embodiments is summarized in FIG. 9C. Referring to FIG. 9C, the bit names 901 for packet “n+1” BCH block 4, e.g., the channel and bit position on which they are carried, may differ for 2- and 3-packet super-packets, in some embodiment. In some embodiments, for subpacket “n+1”, the names of the bits are updated to reflect the bit positions in an un-coded 8 bit word to be TMDS encoded.

FIG. 9D is a diagram of an example of bit placement in 2-packet super-packets, according to some embodiments. FIG. 9D depicts an example in which the packet data illustrated in FIG. 9B and FIG. 9C are loaded into 2-packet super-packets. The bit placement shown in FIG. 9D is similar to the bit placement shown in FIG. 2C. FIG. 9D shows that the value of “0” is placed on bits D4, D5 and D7 of Channel 0, while FIG. 2C shows that the values of HSYNC, VSYNC, and X are placed on bits D4, D5 and D7 of Channel 0, respectively.

In some embodiments, the placement of packet N+1 BCH Block 4 is different for a 2-packet super-packet and a 3-packet super-packet.

FIG. 10A is a diagram of an example of loading standard packets into 3-packet super-packets, according to some embodiments. In some embodiments, standard packets, e.g., those shown from FIG. 8A, are loaded into 3-packet super-packets and transmitted. FIG. 10A depicts an exemple of transmitting the packets shown in FIG. 8A using 3-packet super-packets. Referring to FIG. 10A, following a first active video period, 3-packet super-packets can be transmited in the order of a first 3-packet super-packet SP11 with the audio sample packets A1, A2, A3 loaded on the bottom, middle and top thereof, respectively, a second 3-packet super-packet SP12 with the audio sample packet A4 and two Null packets loaded on the bottom, middle and top thereof, respectively, a third 3-packet super-packet SP13 loaded with the audio sample packet AS and the InfoFrame packets IF0 and IF1 on the bottom, middle and top thereof, respectively, a fourth 3-packet super-packet SP14 loaded with the InfoFrame packets IF2 and IF3 and a Null packet on the bottom, middle and top thereof, respectively, and a fifth 3-packet super-packet SP15 loaded with the sample packet A6 and two Null packets on the bottom, middle and top thereof, followed by another active video period.

In some embodiments, minor variations in the grouping of these packets and the addition of Null Packets are permissible. In some embodiments, the order of the standard packets (e.g., A1, A2, A3, A4, A5, IF0, IF1, IF2, IF3, A6) as shown in FIG. 8A is preserved while minor variations in the grouping of these packets and the addition of Null Packets are permissible.

FIG. 10B is a diagram of an example of naming (or renaming) bits for subpacket “n+1” for loading into a 3-packet super-packet, according to some embodiments. In some embodiments, the loading of the 3-packet super-packet is specified in terms of BCH blocks. An examplary naming of the bits for subpacket “n+1” using BCH block lables according to some embodiments is summarized in FIG. 10B.

In some embodiments, the BCH block labels take the form [Num1][AlphaChar][Num2], where [Num1] indicates a character position on which the bit will reside in a 32 character long packet, [AlphaChar] indicates a channel on which the bit will be carried, and [Num2] indicates a bit position on which the bit will reside on an un-encoded/post-decoded 8-bit word. In some embodiments, [Num2] can have a value “A”, “B”, “C”, or “D”, which indicate “channel 0,” “channel 1,” “channel 2”, and “channel 3,” respectively. In some embodiments, the channel 3 serves as a clock channel in a 3-data plus 1-clock channel operation. For example, the BCH block label “0D6” refers to character 0, channel 3, and bit position 6 in an un-encoded/post-decoded character, in some embodiments. In some embodiments, for subpacket “n+1”, the names of the bits are updated to reflect the bit positions in an un-coded 8 bit word to be TMDS encoded. Referring to FIG. 10B, the bit names 1001 for packet “n+1” BCH block 4, e.g., the channel and bit position on which they are carried, may differ for 2- and 3-packet super-packets, in some embodiment.

FIG. 10C is a diagram of an example of naming (or renaming) bits for subpacket “n+2” for loading into a 3-packet super-packet, according to some embodiments. In some embodiments, the same definition of the BCH block labels as used in FIG. 10B, is used in naming bits for subpacket “n+2” for loading into a 3-packet super-packet. An examplary naming of the bits for subpacket “n+2” using BCH block lables according to some embodiments is summarized in FIG. 10C. In some embodiments, for subpacket “n+2”, the names of the bits are again updated to reflect the bit positions in the un-coded 8 bit word to be TMDS encoded.

FIG. 10D is a diagram of an example of bit placement in 3-packet super-packets, according to some embodiments. FIG. 10D depicts an example in which the packet data illustrated in FIG. 9B, FIG. 10B and FIG. 10C are loaded into 3-packet super-packets. The bit placement shown in FIG. 10D is similar to the bit placement shown in FIG. 2E. FIG. 10D shows that the block 4 of packet N+1 is placed on bit D2 of Channel 3 and the block 4 of packet N+2 is placed on bit D2 of Channel 3 and the block 4 of packet N+1 is placed on bit D3 of Channel 3. In some embodiments, the placement of packet N+1 BCH Block 4 is different for a 2-packet super-packet and a 3-packet super-packet.

In some embodiment, super-packet delivery rules can be defined so that when transmitting super-packets, source devices may place super-packets in Data Islands according to the super-packet delivery rules. In some embodiments, the super-packet delivery rules include a rule that Data Islands may contain at least one super-packet, thereby limiting the Data Island to a minimum duration to 36 characters. In some embodiments, the super-packet delivery rules include a rule that Data Islands may contain at least one but not more than 18 complete super-packets carrying from 1 to 54 packets. In some embodiments, the super-packet delivery rules include a rule that when super-packets are enabled, all Data Island Packet Data may be transported in super-packets and standard packets may not be transmitted. In some embodiments, the super-packet delivery rules include a rule that sources may not transmit standard packets and super-packets when super-packet mode is enabled. In some embodiments, the super-packet delivery rules include a rule that a Data Island may contain standard packets or super-packets, but may not contain both. In some embodiments, the super-packet delivery rules include a rule that when super-packets are enabled, scrambling as defined in HDMI 2.0a may be enabled.

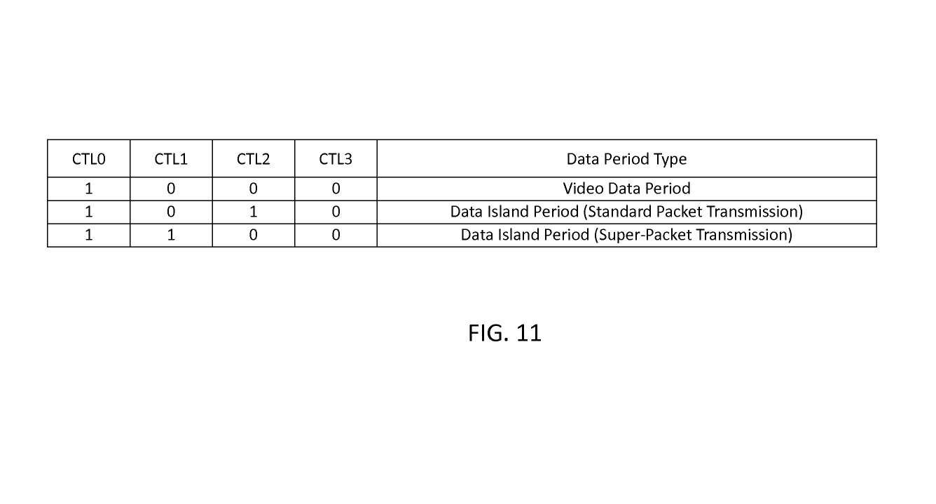

FIG. 11 is a chart of an example of preambles for preambles for each data period type, according to some embodiments. In some embodiments, in addition to video data period and Data Island period preambles, a new preamble may be defined to identify Data Islands that includes super-packets. Referring to FIG. 11, a preamble for the type of data period that follows includes values of CTL0, CTL1, CTL2, and CTL3, in some embodiments. For example, referring to FIG. 11, a preamble for the type of “Video Data Period” or a Video Data Preamble control code is defined as a sequence of values in CTL0, CTL1, CTL2 and CTL3, i.e., “1000”, in some embodiments. In some embodiments, the “Video Data Period” type indicates that the following data period contains video data, beginning with a Video Guard Band. In some embodiments, the “Data Island (Standard Packet Transmission)” type indicates that the following data period is an HDMI compliant Data Island, beginning with a Data Island Guard Band containing standard packets. In some embodiments, the “Data Island (Super-packet transmission)” type indicates that the following data period is an HDMI compliant Data Island, beginning with a Data Island Guard Band containing 2 packet super-packets or 3-packet super-packets. In some embodiments, the transition from TMDS control characters to Guard Band characters following this preamble sequence identifies the start of the Data Period. In some embodiments, the Data Island Preamble control code (“1010”) may not be transmitted except for use during a Preamble period.

In some embodiments, some requirements or restrictions in relation to compression may be defined and applied. For example, some embodiments define a requirement that source and sink devices capable of supporting compression support super-packets in both compressed and uncompressed modes of operation. Some embodiments define a requirement that source and sink devices utilize super-packets when compression is active. Some embodiments define a requirement that source and sink devices do not utilize standard packets when compression is active.

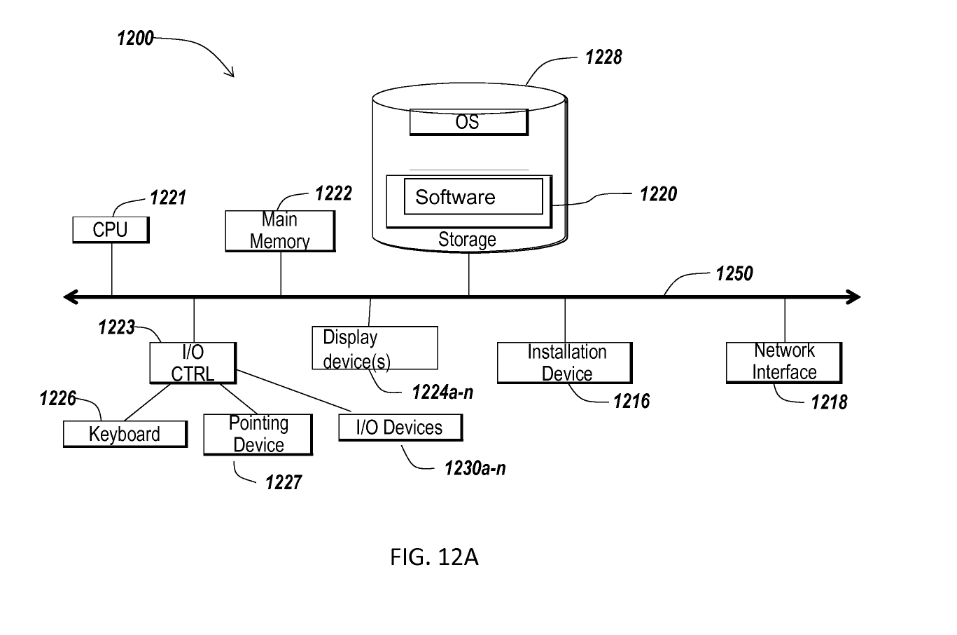

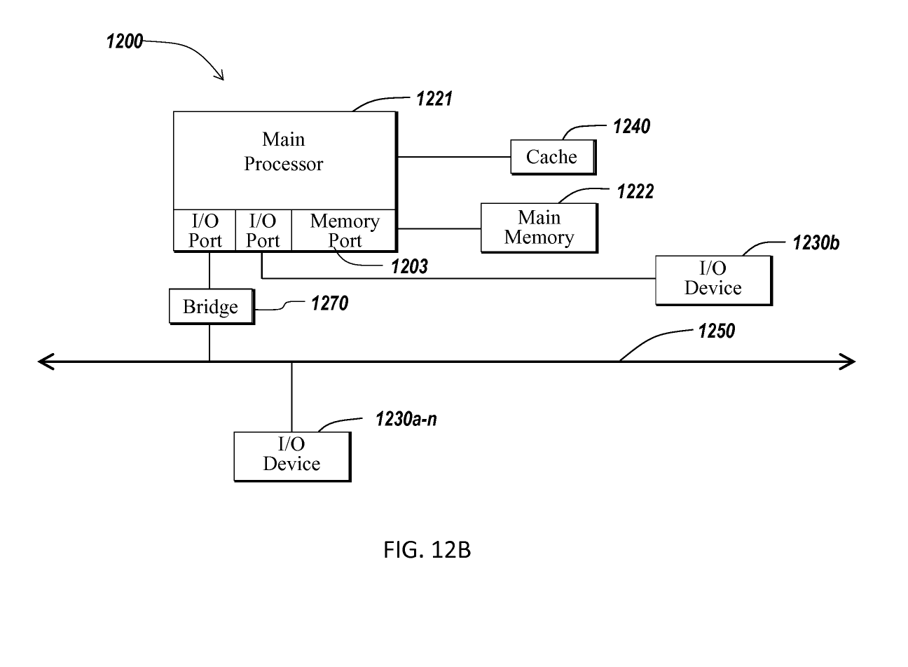

FIGS. 12A and 12B depict block diagrams of a computing device 1200 useful for practicing an embodiment of the HDMI transmitter 102, HDMI receiver 106, HDMI source 100, HDMI sink 104 (see FIG. 1A), or the DSC compression engine 242 (see FIG. 2F). In some embodiments, the computing device 1200 is configured to perform various methods for transporting HD video over HDMI. For example, in some embodiments, the computing device 1200 is configured to map BCH blocks to TMDS channels (see FIGS. 1C and 2C-2E), adjust video container timing (see FIG. FIG. 2A), perform placement of DSC data in channels (see FIG. 2F), perform placement of packets within a video frame (see FIGS. 3A-3B), map parity bits to TMDS channels (see FIGS. 3C-3D), insert mini-packet within a video line (see FIG. 3E), map from a video timing to a video container (see FIGS. 6A-6B), transmit standard packets (see FIG. 8A), load standard packets into 2-packet super-packets (see FIGS. 9A-9C), load standard packets into 3-packet super-packets (see FIGS. 10A-10C), name bits for subsequent subpackets for loading into a 2-packet super-packet and 3-packet super-packet (see FIGS. 9B, 9C, 10B, 10C), perform bit placement in 2-packet or 3-packet super-packets (see FIGS. 9D and 10D), or perform placement of preambles for each data period type (see FIG. 11). Computing device 1200 can be or be part of source 100 or sink 104 (FIG. 1A).

As shown in FIGS. 12A and 12B, each computing device 1200 includes a central processing unit 1221, and a main memory unit 1222. As shown in FIG. 12A, a computing device 1200 may include a storage device 1228, an installation device 1216, a network interface 1218, an I/O controller 1223, display devices 1224a-1224n, a keyboard 1226 and a pointing device 1227, such as a mouse. The storage device 1228 may include, without limitation, an operating system and/or software. As shown in FIG. 12B, each computing device 1200 may also include additional optional elements, such as a memory port 1203, a bridge 1270, one or more input/output devices 1230a-1230n (generally referred to using reference numeral 1230), and a cache memory 1240 in communication with the central processing unit 1221.

The central processing unit 1221 is any logic circuitry that responds to and processes instructions fetched from the main memory unit 1222. In many embodiments, the central processing unit 1221 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 1200 may be based on any of these processors, or any other processor capable of operating as described herein.

Main memory unit 1222 may be one or more memory chips capable of storing data and allowing any storage location to be directly accessed by the microprocessor 1221, such as any type or variant of Static random access memory (SRAM), Dynamic random access memory (DRAM), Ferroelectric RAM (FRAM), NAND Flash, NOR Flash and Solid State Drives (SSD). The main memory 1222 may be based on any of the above described memory chips, or any other available memory chips capable of operating as described herein. In the embodiment shown in FIG. 12A, the processor 1221 communicates with main memory 1222 via a system bus 1250 (described in more detail below). FIG. 12B depicts an embodiment of a computing device 1200 in which the processor communicates directly with main memory 1222 via a memory port 1203. For example, in FIG. 12B the main memory 1222 may be DRDRAM.

FIG. 12B depicts an embodiment in which the main processor 1221 communicates directly with cache memory 1240 via a secondary bus, sometimes referred to as a backside bus. In other embodiments, the main processor 1221 communicates with cache memory 1240 using the system bus 1250. Cache memory 1240 typically has a faster response time than main memory 1222 and is provided by, for example, SRAM, BSRAM, or EDRAM. In the embodiment shown in FIG. 12B, the processor 1221 communicates with various I/O devices 1230 via a local system bus 1250. Various buses may be used to connect the central processing unit 1221 to any of the I/O devices 1230, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 1224, the processor 1221 may use an Advanced Graphics Port (AGP) to communicate with the display 1224. FIG. 12B depicts an embodiment of a computer 1200 in which the main processor 1221 may communicate directly with I/O device 1230b, for example via HYPERTRANSPORT, RAPIDIO, or INFINIBAND communications technology. FIG. 12B also depicts an embodiment in which local busses and direct communication are mixed: the processor 1221 communicates with I/O device 1230a using a local interconnect bus while communicating with I/O device 1230b directly.

A wide variety of I/O devices 1230a-1230n may be present in the computing device 1200. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 1223 as shown in FIG. 12A. The I/O controller may control one or more I/O devices such as a keyboard 1226 and a pointing device 1227, e.g., a mouse or optical pen. Furthermore, an I/O device may also provide storage and/or an installation medium 1216 for the computing device 1200. In still other embodiments, the computing device 1200 may provide USB connections (not shown) to receive handheld USB storage devices such as the USB Flash Drive line of devices manufactured by Twintech Industry, Inc. of Los Alamitos, Calif.

Referring again to FIG. 12A, the computing device 1200 may support any suitable installation device 1216, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 1200 may further include a storage device, such as one or more hard disk drives or redundant arrays of independent disks, for storing an operating system and other related software, and for storing application software programs such as any program or software 1220 for implementing (e.g., configured and/or designed for) the systems and methods described herein. Optionally, any of the installation devices 1216 could also be used as the storage device. Additionally, the operating system and the software can be run from a bootable medium.

Furthermore, the computing device 1200 may include a network interface 1218 to interface to the network 1204 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 1200 communicates with other computing devices 1200′ via any type and/or form of gateway or tunneling protocol such as Secure Socket Layer (SSL) or Transport Layer Security (TLS). The network interface 1218 may include a built-in network adapter, network interface card, PCMCIA network card, card bus network adapter, wireless network adapter, USB network adapter, modem or any other device suitable for interfacing the computing device 1200 to any type of network capable of communication and performing the operations described herein.

In some embodiments, the computing device 1200 may include or be connected to one or more display devices 1224a-1224n. As such, any of the I/O devices 1230a-1230n and/or the I/O controller 1223 may include any type and/or form of suitable hardware, software, or combination of hardware and software to support, enable or provide for the connection and use of the display device(s) 1224a-1224n by the computing device 1200. For example, the computing device 1200 may include any type and/or form of video adapter, video card, driver, and/or library to interface, communicate, connect or otherwise use the display device(s) 1224a-1224n. In one embodiment, a video adapter may include multiple connectors to interface to the display device(s) 1224a-1224n. In other embodiments, the computing device 1200 may include multiple video adapters, with each video adapter connected to the display device(s) 1224a-1224n. In some embodiments, any portion of the operating system of the computing device 1200 may be configured for using multiple displays 1224a-1224n. One ordinarily skilled in the art will recognize and appreciate the various ways and embodiments that a computing device 1200 may be configured to have one or more display devices 1224a-1224n.

In further embodiments, an I/O device 1230 may be a bridge between the system bus 1250 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed is:

1. A system for transporting high definition multimedia data via a high-definition multimedia interface (HDMI), comprising:
an HDMI source in communication with an HDMI receiver via a plurality of channels, the HDMI source configured to:
receive uncompressed multimedia data at a first number of characters;
compress the multimedia data to a second number of characters;
transmit a first portion of the compressed multimedia data comprising subsequent packets interleaved via two channels of the plurality of channels; and
transmit a second portion of the compressed multimedia data comprising a third packet via a third channel of the plurality of channels.

2. The system of claim 1, wherein the two channels of the plurality of channels utilize transition minimized differential signaling (TMDS) encoding.

3. The system of claim 1, wherein the third channel comprises a clock channel.

4. The system of claim 1, wherein the third channel utilizes ANSI 8b/10b encoding.

5. The system of claim 2, wherein the two channels of the plurality of channels utilize ANSI 8b/10b encoding.

6. The system of claim 1, wherein the HDMI source is further configured to transmit the third packet interleaved between the third channel and a fourth channel of the plurality of channels.

7. The system of claim 1, wherein each of packets of the compressed multimedia data includes two or more HDMI standard packets.

8. The system of claim 7, wherein each of packets of the compressed multimedia data includes at least one null packet.

9. A method for transporting high definition multimedia data via a high-definition multimedia interface (HDMI), comprising:
compressing uncompressed video data into compressed video data; and
adjusting a timing of the compressed video data, comprising at least one of:
adjusting a horizontal blanking interval of the compressed video data by dividing an horizontal blanking interval of uncompressed video data into two or more; and
adjusting a vertical blanking interval of the compressed video data by dividing a vertical blanking interval of uncompressed video data into two or more.

10. The method of claim 9, wherein the adjusting the time of the compressed video data includes:
adjusting a horizontal blanking interval of the compressed video data by dividing an horizontal blanking interval of the uncompressed video data into two; and
adjusting a vertical blanking interval of the compressed video data by dividing a vertical blanking interval of the uncompressed video data into two.

11. The method of claim 9, wherein the adjusting the time of the compressed video data includes:
adjusting a horizontal blanking interval of the compressed video data by dividing an horizontal blanking interval of the uncompressed video data into four; and
setting a vertical blanking interval of the compressed video data to a vertical blanking interval of the uncompressed video data.

12. The method of claim 9, wherein the adjusting the time of the compressed video data includes:
setting a horizontal blanking interval of the compressed video data to a horizontal blanking interval of the uncompressed video data; and
adjusting a vertical blanking interval of the compressed video data by dividing a vertical blanking interval of the uncompressed video data into four.

13. The method of claim 9, further comprising:
before compression, dividing each line of the uncompressed video data into a plurality of uncompressed horizontal slices; and
compressing the plurality of uncompressed horizontal slices into a corresponding plurality of compressed slices to obtain compressed video data.

14. The method of claim 13, further comprising adjusting a timing of the compressed video data by combining portions of the plurality of compressed slices into a container line of the compressed video data.

15. A method for transporting high definition multimedia data via a high-definition multimedia interface (HDMI), comprising:
dividing a forward error correction (FEC) packet into a plurality of mini-packets, each carrying a subset of FEC parity bits of the FEC packet;
inserting mini-packets into a video container line including active video data; and
transmitting the mini-packets on the video container line.

16. The method of claim 15, wherein the inserting the mini-packets into the video container line includes inserting the mini-packets periodically into the video container line.

17. The method of claim 15, wherein the mini-packets are free of packet headers.

18. The method of claim 15, further comprising:
carrying color phase across an interval between transmissions of mini-packets;
pausing color phase during a period of transmissions of mini-packets; and
synchronize color phase with the periodic insertion of mini-packets.

19. The method of claim 15, further comprising:
transmitting, prior to transmission of any video container lines, a picture parameter set (PPS) packet having information to decode a Display Stream Compression (DSC) compressed picture.

20. The method of claim 15, wherein the transmitting of the PPS packet includes:
transmitting the PPS packet in a burst of subpackets at a free data island during a vertical blanking interval (VBI).
